(19) United States
(12) Patent Application Publication
(10) Pub. No.: US 2025/0007592 A1
(43) Pub. Date: Jan. 2, 2025

(54) METHODS AND APPARATUSES FOR CONTROL INFORMATION SIGNALING FOR SMART REPEATERS IN WIRELESS COMMUNICATION SYSTEMS

(71) Applicant: APPLE INC., Cupertino, CA (US)

(72) Inventors: Hong He, San Jose, CA (US); Chunxuan Ye, San Diego, CA (US); Dawei Zhang, Saratoga, CA (US); Haitong Sun, Cupertino, CA (US); Huaning Niu, San Jose, CA (US); Oghenekome Oteri, San Jose, CA (US); Seyed Ali Akbar Fakoorian, San Diego, CA (US); Sigen Ye, San Diego, CA (US); Wei Zeng, Saratoga, CA (US); Weidong Yang, San Diego, CA (US); Yushu Zhang, Beijing (CN)

(21) Appl. No.: 18/709,167

(22) PCT Filed: Nov. 25, 2021
(86) PCT No.: PCT/CN2021/133134

§ 371 Date: May 10, 2024

(51) Int. Cl. H04B 7/06; H04L 1/00; H04W 56/00; H04W 72/1273; H04W 72/231; H04W 72/51

(52) U.S. Cl. CPC H04B 7/06952; H04B 7/0626; H04L 1/0061; H04W 56/0015; H04W 72/1273; H04W 72/231; H04W 72/51

(57) ABSTRACT

Systems and methods for the use of smart repeater (SMR) control information from a base station to an SMR to control aspects of SMR operation are disclosed herein. The SMR control information may control the operation of to either or both of an SMR synchronization signal block (SSB) beam sweep or an SMR channel state information reference signal (CSI-RS) beam sweep. An SMR may report, to a base station, SMR capability information; receive, from the base station, SMR control information corresponding to the SMR capability information that includes a first portion configuring an SSB beam sweep and/or a second portion configuring a CSI-RS beam sweep; and perform, based on the SMR control information, one or both of the SMR SSB beam sweep and the SMR CSI-RS beam sweep. Systems and methods for signaling the SMR control information between the SMR and the base station are also provided.

### TECHNICAL FIELD

This application relates generally to wireless communication systems, including wireless communications systems having smart repeaters (SMRs) that relay information between one or more UEs and a base station.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for the use of SMR control information to control an SSB beam sweep at an SMR, according to embodiments herein.

FIG. 2 illustrates a diagram for SSB resource allocation between a base station and an SMR according to an offset, according to an embodiment.

FIG. 3 illustrates a diagram for SSB resource allocation between a base station and an SMR according to an indications of particular SSB positions for SSBs of an SSB burst set to be used by an SMR for an SMR SSB beam sweep, according to an embodiment.

FIG. 4 illustrates a diagram for the use of SMR control information to control a CSI-RS beam sweep at an SMR, according to embodiments herein.

FIG. 5 illustrates a diagram showing the general structure for the use of SMR control information to identify one or more symbols for one or more contiguous slots within a period of a CSI-RS periodicity to use to perform an SMR CSI-RS beam sweep, according to various embodiments.

FIG. 6 provides a diagram for SLIV use to identify one or more symbols of one or more contiguous slots within a period of a CSI-RS periodicity to use to perform an SMR CSI-RS beam sweep, according to an embodiment.

FIG. 7 provides a diagram for SLIV use to identify one or more symbols of one or more contiguous slots within a period of a CSI-RS periodicity to use to perform an SMR CSI-RS beam sweep, according to an embodiment.

FIG. 8 illustrates a diagram for the use of a bitmap to indicate symbol locations for one or more of symbols within one or more contiguous slots 504 that are to be used to transmit CSI-RS resources during a SMR CSI-RS beam sweep, according to an embodiment.

FIG. 9 illustrates a diagram for the use of a bitmap to indicate symbol locations for one or more of symbols within one or more contiguous slots that are to be used to transmit CSI-RS resources during a SMR CSI-RS beam sweep, according to an embodiment.

FIG. 10 illustrates a diagram showing the use of all symbols of one or more contiguous slots to transmit CSI-RS resources during an SMR CSI-RS beam sweep, according to an embodiment.

FIG. 11 illustrates a diagram showing the delivery of SMR control information, according to embodiments disclosed herein.

FIG. 12 illustrates a diagram showing a delivery of SMR control information using high-layer signaling as scheduled by DCI, according to an embodiment.

FIG. 13 illustrates a diagram showing delivery of SMR control information using DCI, according to an embodiment.

FIG. 14 illustrates a diagram showing delivery of SMR control information using DCI, according to an embodiment.

FIG. 15 illustrates a table showing the repurposing of two reserved bits from a short message field in DCI format 1_o to indicate modified SMR control information availability to an SMR, according to an embodiment.

FIG. 16 illustrates a method of an SMR, according to an embodiment.

FIG. 17 illustrates a method of a base station, according to an embodiment.

FIG. 18 illustrates an example architecture of a wireless communication system, according to embodiments disclosed herein.

FIG. 19 illustrates a system for performing signaling between an SMR and a base station, according to embodiments disclosed herein.

FIG. 20 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

UE coverage is a fundamental aspect of wireless communication system deployments. Mobile operators may rely on different types of network nodes to offer blanket coverage in their deployments. The deployment of full-stack cells within a wireless communication system is one option for providing UE coverage, but this may not be always possible or economically viable in every location (e.g., in cases where there is no availability of a backhaul from the location to the core network, and/or an unreasonable amount of expense for establishing such a backhaul and/or the full-stack cell). As a result, new types of network nodes are considered to increase mobile operators' flexibility for their wireless communication system network deployments.

One such example of these new network nodes is the smart repeater (SMR). An SMR may communicate signals back and forth between one or more UE that are served by the SMR via a link (e.g., a Un link) between the SMR and the base station. This may be useful in the case where, for example, the base station (e.g., having the backhaul to the core network of the wireless communication system) cannot directly serve the UE (e.g., due to distance and/or interference), but the SMR can directly serve the UE. The link between the SMR and the base station may be possible because of, for example, an ability of the SMR and/or the base station to use a necessary transmission power and/or more accurate and/or precise beamforming (e.g., greater/better than that which can reasonably be provided for a regular use case of a UE). Through this relaying between the SMR and the base station, the effective possible coverage range and/or performance for the UE within the wireless communication network is improved. Note that such interference considerations may be particularly relevant in the case of higher frequency operation of the base station and/or the SMR (e.g., in FR2), due to the tendency of such relatively higher frequency signaling to be more impacted by interference sources and/or to have a lesser transmission range than relatively lower frequency signaling.

An SMR may itself be enhanced over conventional RF repeaters with the capabilities to receive, process, and implement SMR control information from the network (e.g., as received from the base station). Among other things, SMR control information could allow an SMR to perform any amplify-and-forward operations in a more efficient manner. Potential benefits stemming from the use of such SMR control information may include mitigation of unnecessary noise amplification, better spatial directivity for SMR transmissions and/or receptions, and/or simplified network integration between the SMR and a base station. Note that herein, such SMR control information may be referred to more simply as “control information,” and context will make it apparent that such information is SMR control information (e.g., control information between the base station and the SMR).

An SMR may be capable of sending beamformed signals to one or more of the UEs that it serves. It is contemplated that one or more of the above benefits could be achieved by using SMR control information to enable network control (at least in part) of beamforming operation at an SMR. Accordingly, disclosed herein are embodiments that use SMR control information to enable and/or control beam-formed communications between an SMR, such that spectrum efficiency and coverage aspects related to the SMR may be improved.

This disclosure uses the following definitions:
gNB-UE: a UE that is in coverage of a base station (e.g., a gNB in a 5G NR system) and is connected to the base station.
SMR-UE: a UE that is in coverage of a SMR and is connected to the SMR.
Uu link: A connection between a UE and an SMR, or between a UE and a base station. This link may also sometimes be referred to as an “access link.”
Un link: A connection between the base station and the SMR. This link may also sometimes be referred to as a “backhaul link.”
SMR-PDSCH: A physical downlink shared channel (PDSCH) that is transmitted by the base station and that targets the SMR (that may be used for, e.g., SMR control information).
SMR-PDCCH: A physical downlink control channel (PDCCH) that is transmitted by the base station and targets the SMR (that may be used for, e.g., SMR control information).

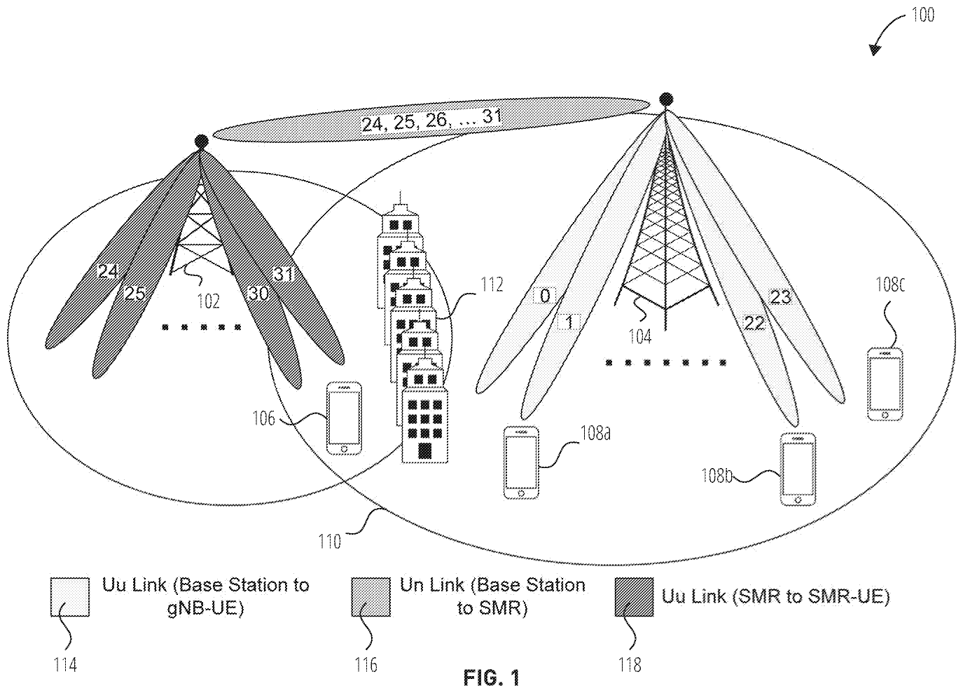

FIG. 1 illustrates a diagram 100 for the use of SMR control information to control a synchronization signal block (SSB) beam sweep at an SMR 102, according to embodiments herein. The diagram 100 illustrates an SMR 102 that operates with a base station 104. In the diagram 100, the SMR 102 may provide coverage to an SMR-UE 106, while the base station 104 provides coverage to gNB-UEs 108a through 108c.

Herein, a SSB beam sweep performed by an SMR may be sometimes referred to as an “SMR SSB beam sweep.” Further, SMR control information (or a portion thereof) that configures an SMR SSB beam sweep may be sometimes referred to herein as “SMR SSB control information.”

It may be that even though the SMR-UE 106 is within a theoretical range 110 for the base station 104, direct signaling between the SMR-UE 106 and the base station 104 may not be able to be reasonably accomplished due to the interference of the obstructions 112 (which have been illustrated as buildings, but could alternatively be other man-made items, or natural/geographical features or events). Accordingly, coverage for the SMR-UE 106 is provided by the SMR 102 rather than the base station 104, with the SMR 102 relaying signaling between the SMR-UE 106 and the base station 104 on a Un link.

Beam sweeping is a technique that transmits different downlink signals or channels in a burst in different beamformed directions. An SSB beam sweep (or beam sweep for SSB transmissions) may include the transmission of one or more SSBs of an SSB burst set using one or more associated beams in different transmission directions. SSB beam sweeps are used in wireless communication systems to enable a receiving UE to use the beam-associated SSBs to determine 1) synchronization with the cell and 2) directionality of signaling to/from the UE on the cell (among other things).

The diagram 100 illustrates a case where the use of an SSB beam sweep (or “beam sweep for the SSB transmission”) by the SMR 102 is controlled/configured by the base station 104. The SSB beam sweep by the SMR may accordingly allow (potential) SMR-UE (such as the SMR-UE 106) to determine synchronization and/or directionality relative to signaling between the SMR-UE and the SMR 102 such that communications between the SMR-UE and the network can be established through the SMR 102.

In the embodiment illustrated in FIG. 1, the base station 104 determines that a total of 32 SSBs are to be transmitted. In the diagram 100, these SSBs are illustrated as indexed from 0 to 31. The base station 104 further determines that SSBs 0 through 23 make up a first SSB burst set for a first SSB beam sweep performed by the base station 104 (a base station SSB beam sweep) and that SSBs 24 through 31 make up a second SSB burst set for a second SSB beam sweep performed by the SMR 102 (an SMR SSB beam sweep). Note that these determinations are given by way of example and not by limitation. The total number of SSBs used in the beam sweep(s), and the division of SSBs between the first beam sweep by the base station 104 and the second beam sweep by the SMR 102 could be differently determined by the base station 104.

The base station 104 performs the base station SSB beam sweep using beams corresponding to establishment/use of one or more Uu links 114 between the base station and one or more gNB-UEs (such as the gNB-UEs 108a through 108c). As illustrated in the diagram 100, SSBs 0 through 23 of the first SSB burst set are transmitted by the base station on corresponding beams in this manner as part of this first beam sweep.

The base station 104 also forwards SSBs 24 through 31 as a second SSB burst set to the SMR 102 using a Un link 116 between the base station 104 and the SMR 102. This forwarding may be necessary, as the information contained in the SSBs changes over time according to network status, so the SMR 102 should be regularly provided with up-to-date SSBs.

The SMR 102 then performs the SMR SSB beam sweep using the SSBs of the second SSB burst set that are received on the Un link 116 from the base station. The SMR SSB beam sweep uses beams corresponding to the establishment/use of one or more Uu links 118 between the SMR and one or more SMR-UEs (such as the SMR-UE 106). As illustrated in the diagram 100, SSBs 24 through 31 (e.g., the SSBs forwarded from the base station 104 to the SMR 102 on the Un link 116) of the second SSB burst set are transmitted by the SMR on corresponding beams for this second beam sweep by the SMR 102.

SMR control information signaled between the base station 104 and the SMR 102 may be used to configure an SSB forwarding procedure. In some cases, the SMR control information may include an SMR SSB burst periodicity. This SMR SSB burst periodicity represents a periodicity at which the SMR 102 is to perform SSB sweeps using the SSBs of an SSB burst set that are received on the Un link 116 from the base station 104. In some such wireless communication systems, values of 5 ms, 10 ms, 20 ms, 40 ms, 80 ms, and 160 ms might be available to be provided in such signaling (e.g., according to a specification defining the operation of such a wireless communication system). Note that other values (including values dynamically determined by the base station according to network status) could also be used. It is also contemplated that in some cases, the SMR SSB burst periodicity may be the same as a base station SSB burst periodicity used by the base station 104 for its base station SSB beam sweeps. In such cases where the base station SSB burst periodicity is already known by/signaled to the SMR 102, it may not be necessary to separately and explicitly signal an SMR SSB burst periodicity to the SMR; rather, the SMR may simply use the base station SSB burst periodicity as the SMR SSB burst periodicity in such a case.

In some embodiments, the base station 104 may include an offset value in the SMR control information for the SMR SSB beam sweep. This offset value may be used by the SMR 102 to determine a location (in time) where it will receive the SSB burst set having SSBs that it is to use for the SMR SSB beam sweep from the base station 104.

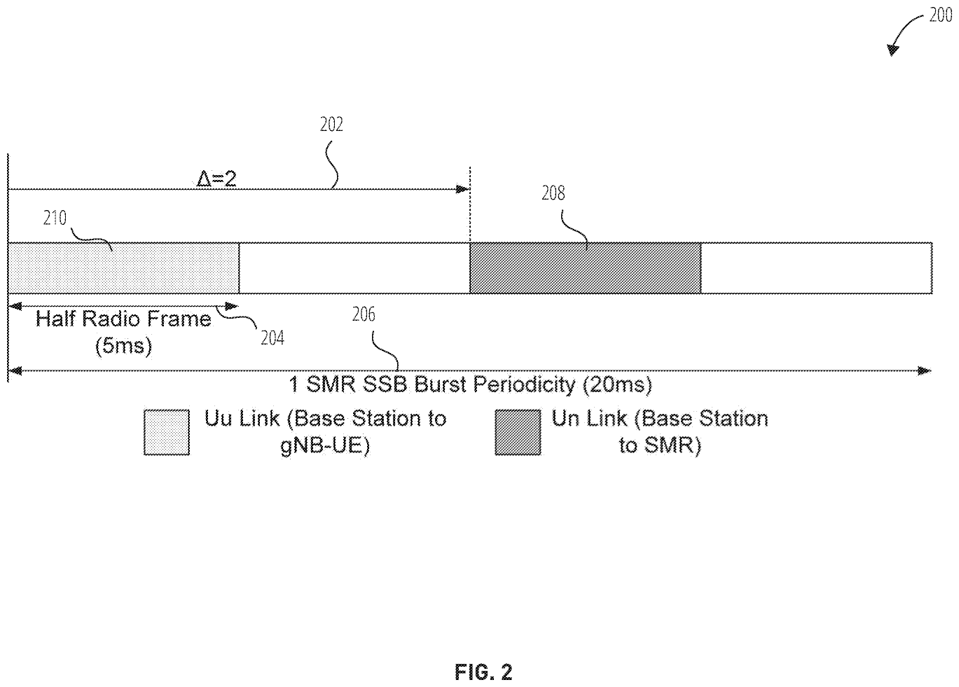

FIG. 2 illustrates a diagram 200 for SSB resource allocation between a base station and an SMR according to an offset 202, according to an embodiment. FIG. 2 illustrates a case where the offset 202 (denoted A in FIG. 2) is signaled in/used according to units of half radio frames. In the illustrated case, the SMR control information provided to the SMR 102 from the base station 104 for the SMR SSB beam sweep indicates that the offset 202 is equal to two.

Accordingly, the SMR 102 measures two half radio frames 204 from the beginning of a period 206 of the SMR SSB burst periodicity being used by the SMR (which in the illustrated case is 20 ms, equal to four half radio frames), and expects to receive an SSB burst set (e.g., the SSBs index from 24 to 31, as discussed in FIG. 1) from the base station 104 for the SMR SSB beam sweep for SMR-UE coverage during the third half radio frame 208 of the period 206. Note that the base station 104 uses the same measurement to correspondingly send the SSB burst set for the SMR SSB beam sweep to the SMR 102.

Note that while the base station SSB beam sweep (e.g., using the SSBs indexed from 0 to 23, as discussed in FIG. 1) for gNB-UE coverage has been illustrated in FIG. 2 as occurring during the first half radio frame 210, there is no inherent restriction on the time location of the base station SSB beam sweep to any particular half radio frame within or relative to the SMR control information provided from the base station 104 to the SMR 102.

Other units for offsets A (other than half radio frames) are contemplated. For example, units for a offset A indication to be provided by the base station 104 to the SMR 102 may be understood relative to an SSB numerology, as defined by a specification controlling the operation of the wireless communication system. In some such cases, an offset A may be given in units of a length of a maximum number of SSBs that are supported when using a current subcarrier spacing.

In some embodiments, the base station 104 may indicate, using SMR control information for an SMR SSB beam sweep, particular SSB positions within a period of an SMR SSB burst periodicity for the SSBs of the SSB burst set that are to be used by the SMR for an SMR SSB beam sweep. These positions may be indicated in, for example, an SMR-ssb-PositionsInBurst information element.

This embodiment may be useful in the cases where, for example, periods of an SMR SSB burst periodicity used by the SMR 102 are of the same length as a single unit of an offset A as described in relation to FIG. 2 (for example, a case where the SMR SSB burst periodicity is set to Sms, and the units of an offset A indication are equal to half radio frames of 5 ms). In such cases, because all SSBs for both the base station beam sweep and the SMR SSB beam sweep accordingly occur within one period of the SMR SSB burst periodicity that is equal to the length of one unit of offset 4, the offset value would not have the granularity necessary to indicate particular time positions within that period of the SMR SSB burst periodicity (e.g., to indicate time positions of SSBs sent to the SMR 102 from base station 104 on the Un link). Such cases may occur, for example, in the case of operation in FR2.

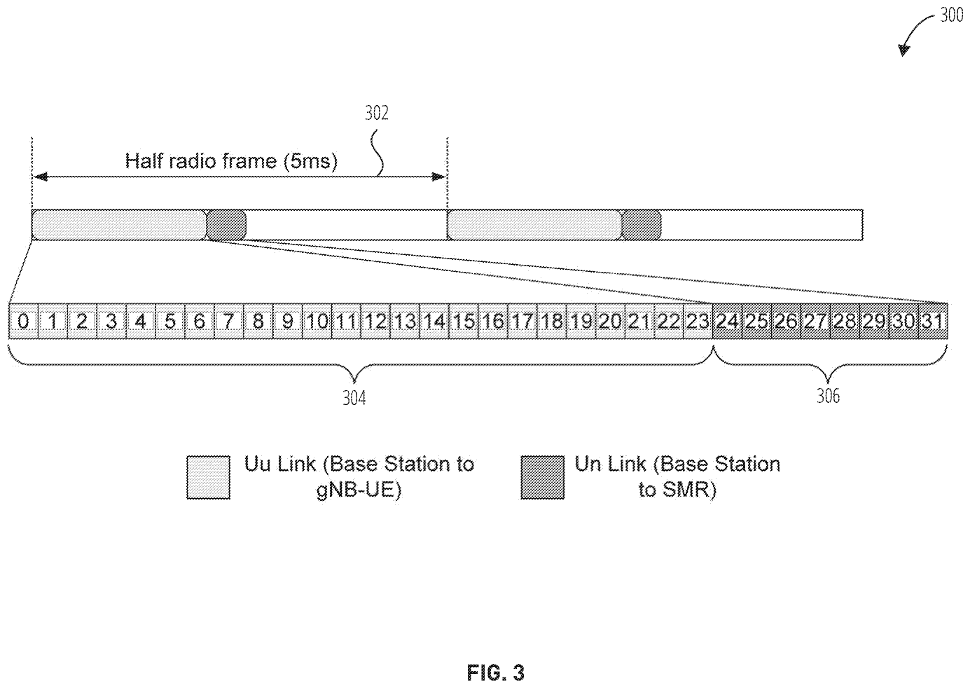

FIG. 3 illustrates a diagram 300 for SSB resource allocation between a base station and an SMR according to an indications of particular SSB positions for SSBs of an SSB burst set to be used by an SMR for an SMR SSB beam sweep, according to an embodiment. FIG. 3 illustrates the case where the SMR SSB burst periodicity is set to 5 ms, which is equal to a half radio frame. It may also be the case that the use of an offset A indication is not useable, because an offset A would be indicated in units of half radio frames (which is not granular enough to indicate positions within a single half radio frame).

By way of illustrative example, the embodiment of FIG. 3 corresponds to the particular SSB index division between the base station 104 and the SMR 102 as described in FIG. 1. Note that other arrangements are possible.

As described in FIG. 1, the base station 104 determines that SSBs 0 through 23 are to be used in a first SSB burst set beam sweep by the base station 104 and that SSBs 24 through 31 are to be used in a second SSB burst set for a beam sweep by the SMR 102. Accordingly, it may be that the SMR control information sent by the base station 104 to the SMR 102 includes an SMR-ssb-PositionsInBurst information element that contains the bitmap
00000000000000000000000011111111
thereby indicating that the SMR 102 should expect to receive SSBs of the second SSB burst set to use for an SMR SSB beam sweep in the last eight SSB positions of the SMR SSB burst periodicity (where these last eight SSB positions correspond to SSBs 24 through 31). Note that the fact that the base station 104 indicates the last eight SSB positions to the SMR 102 is given by way of example and not by limitation. Other SSB positions and amounts of SSB positions (and that are not necessarily consecutive) could be so indicated in other cases.

Accordingly, during the period 302, the base station 104 uses the first SSBs 304 (including SSBs 0 through 23, as illustrated) to perform a base station beam sweep at the base station 104 corresponding to its coverage of gNB-UE(s). Further, the base station 104 transmits the second SSBs 306 (including SSBs 24 through 31, as illustrated) to the SMR 102 on the Un link. The SMR 102 receives these second SSBs 306 and uses them the perform an SMR SSB beam sweep corresponding to its coverage for SMR-UE(s).

In cases using an SMR-ssb-PositionsInBurst information element, it may be that the base station 104 broadcasts a first ssb-PositionsInBurst information element to its gNB-UE(s) that details SSB positions for the SSBs used in the base station SSB beam sweep in a first system information block (SIB). It may further be that the SMR 102 broadcasts a second ssb-PositionsInBurst information element to its SMR-UE(s) that details SSB positions for the SSBs used in the SMR SSB beam sweep in a second SIB. Because different SSBs are used in each of the base station SSB beam sweep and the SMR SSB beam sweep, indications in each of the first and second ssb-PositionsInBurst information elements may differ. For example, the first ssb-PositionsInBurst information element sent by the base station may indicate
11111111111111111111111100000000
corresponding to the first 24 SSBs used in the base station SSB beam sweep, while the second ssb-PositionsInBurst information element sent by the SMR may indicate
00000000000000000000000011111111
corresponding to the last eight SSBs used in the SMR SSB beam sweep. Other bitmaps would correspondingly apply in cases of other arrangements of SSB use than the one illustrated in FIG. 1.

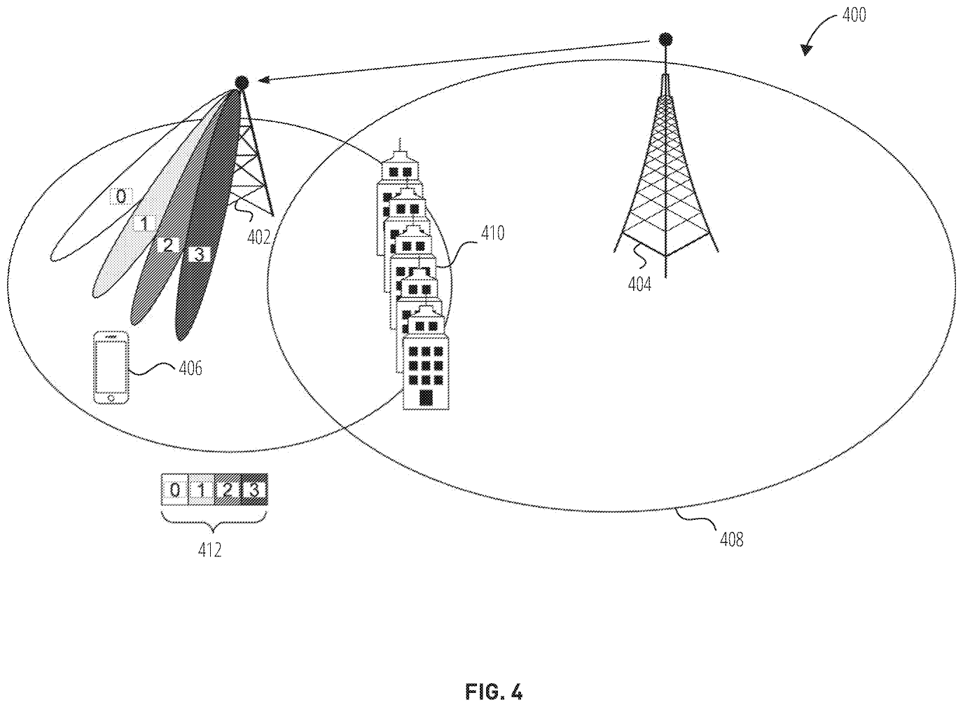

FIG. 4 illustrates a diagram 400 for the use of SMR control information to control a CSI-RS beam sweep at an SMR 402, according to embodiments herein. The diagram 400 illustrates an SMR 402 connects to a base station 404. In the diagram 400, the SMR 402 may provide extended coverage for an SMR-UE 406 (enabling an indirect connection of the SMR-UE 406 to the base station 404).

Herein, a CSI-RS beam sweep performed by an SMR may be sometimes referred to as an “SMR CSI-RS beam sweep.” Further, SMR control information (or a portion thereof) that configures a CSI-RS resource set to be used during an SMR CSI-RS beam sweep may be sometimes referred to herein as “SMR CSI-RS control information.” Such a CSI-RS resource set may include one or more CSI-RS resources in different orthogonal frequency-division multiplexing (OFDM) symbols in the time domain.

In FIG. 4, it may be that the SMR-UE 406 is outside a coverage 408 for the base station 404 (e.g., regardless of any interference concerns as would be caused by the obstructions 410, which may be as the obstructions 112 discussed in FIG. 1). Accordingly, cell coverage for the SMR-UE 406 is provided by the SMR 402 rather than the base station 404, with the SMR 402 relaying/forwarding signaling between the SMR-UE 406 and the base station 404 on a Un link.

A CSI-RS beam sweep may include the transmission of one or more CSI-RS resources of a CSI-RS resource set on one or more associated downlink (DL) beams. Each beam may include one of the one or more CSI-RS resources and may be transmitted in a unique direction. CSI-RS resource(s) of the CSI-RS beam sweep that are received at a UE may be used in wireless communications networks to enable the UE to fine tune its beamforming with the transmitting entity and/or to provide feedback regarding the received CSI-RS resources to the network such that a beamforming of the transmitting entity can be more finely tuned (among other things). This process may be performed to fine tune any previously established beam(s) between the transmitting entity and the UE (e.g., as may have been established through the use of an SSB beam sweep operation).

The diagram 400 illustrates a case where the use of a CSI-RS beam sweep by the SMR 402 is controlled/configured by the base station 404. The base station 404 sends SMR control information to the SMR 402 that configures a CSI-RS beam sweep to be used by the SMR 402 (an SMR CSI-RS beam sweep) on a Un link. The SMR CSI-RS beam sweep by the SMR 402 may accordingly allow a SMR-UE (such as the SMR-UE 406) to improve its own reception beamforming relative to the SMR 402 and/or provide feedback relative to signaling between the SMR-UE 406 and the SMR 402 such that a beamforming used by the SMR 402 of the SMR-UE 406 may be improved. In this manner, signaling between the SMR-UE 406 and the SMR 402 (and thus ultimately with the network) can be accordingly generally improved.

In the embodiment illustrated in FIG. 4, the base station 104 determines that the SMR 402 is to perform an SMR CSI-RS beam sweep for four CSI-RS resources indexed from 0 through 3 of a CSI-RS resource set 412, with each CSI-RS resource being sent on a different beam. The diagram 400 accordingly illustrates each CSI-RS resource (indexed 0 through 3) of the CSI-RS resource set 412 on a corresponding beam. Note that the use of a CSI-RS resource set having four CSI-RS resources is given by way of example and not by limitation. The CSI-RS resource set to use for the SMR CSI-RS beam sweep by the SMR 102 could be differently determined by the base station 104.

SMR control information signaled between the base station 404 and the SMR 402 may be used to configure an SMR CSI-RS beam sweep procedure (e.g., to configure for the CSI-RS resources to use in the SMR CSI-RS beam sweep). In some cases, the SMR control information may include a configuration of the CSI-RS resource set that is to be used by the SMR 402 for the SMR CSI-RS beam sweep. The CSI-RS resource set may be understood to be a non-zero-power (NZP) CSI-RS (NZP-CSI-RS) resource set, since NZP CSI-RS resources may be suitable for beamforming tuning and/or feedback processes at the SMR-UE 406, as described above. It may also be the understood that an SMR-UE (such as the SMR-UE 406) has been configured with a CSI-ReportConfig information element with a “reportQuantity” value set to “cri-RSRP” or “cri-SINR” (such that the UE is properly configured to use the transmitted CSI-RS resources in the manner described).

The CSI-RS resource set configuration sent by a base station to an SMR may identify one or more symbols of one or more contiguous slots within one or more periods of a CSI-RS periodicity that are to be used to perform the SMR CSI-RS beam sweep. In other words, the CSI-RS resource set configuration may inform the SMR 402 of the time domain location for CSI-RS resources corresponding to the identified symbols.

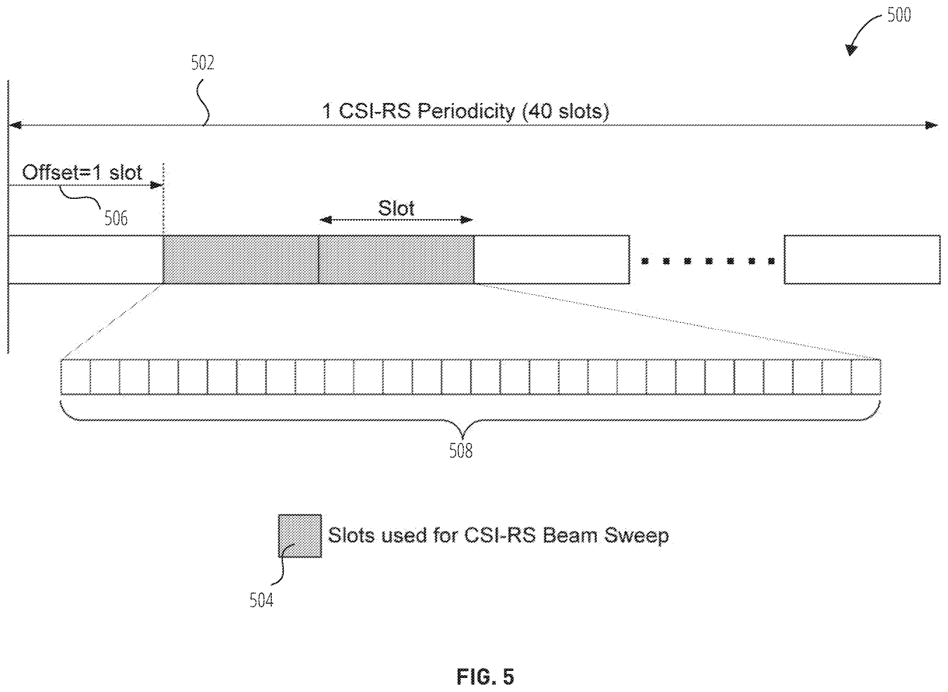

FIG. 5 illustrates a diagram 500 showing the general structure for the use of SMR control information to identify one or more symbols for one or more contiguous slots 504 within a period of a CSI-RS periodicity to use to perform an SMR CSI-RS beam sweep, according to various embodiments. The CSI-RS resource set configuration may indicate a CSI-RS periodicity and an offset. In some cases, the base station may determine the periodicity and offset to signal to the SMR as established by a specification defining the operation of the wireless communication system.

The CSI-RS periodicity may be a periodicity (in slots) at which the SMR is to perform SMR CSI-RS beam sweeps using the CSI-RS resource set. The SMR accordingly identifies and uses a CSI-RS periodicity for the CSI-RS resource set. In the example of FIG. 5 a period 502 of a 40 slot CSI-RS periodicity is shown by way of example (and not by way of limitation, as other periodicities are contemplated in other embodiments)

The offset (also given in a number of slots) may be used to measure, from the beginning of the period of the CSI-RS periodicity, to the location at which a first of the one or more contiguous slots having the symbols that will be used for the SMR CSI-RS beam sweep begins. In the example of FIG. 5, an offset 506 of one slot is shown by way of example (and not by way of limitation, as other offsets are contemplated in other embodiments).

In some embodiments, the CSI-RS resource set configuration may indicate a number of the one or more contiguous slots having the symbols that will be used for the SMR CSI-RS beam sweep. Accordingly, in embodiments where a number of slots is received, the SMR can identify the one or more contiguous slots by using the offset relative to the start of the period and the value for the number of the one or more contiguous slots. Thus, in some cases corresponding to the example of FIG. 5, the base station explicitly indicates that two contiguous slots 504 contain symbols to be used for the SMR CSI-RS beam sweep (though this may not always be the case).

As illustrated, the two contiguous slots 504 are made up of the symbols 508. Because the example of FIG. 5 assumes that the symbols to be used for the SMR CSI-RS beam sweep are located within the two contiguous slots 504, 28 total symbols (14 per slots) are illustrated. Note that the use of 28 symbols in two slots should accordingly be understood as an example, and not by way of limitation (as, as discussed above, other embodiments may use a different number of one or more contiguous slots).

Processes used by an SMR for determining the particular symbols that correspond to the CSI-RS resource set that is used for the SMR CSI-RS beam sweep are now described.

In some embodiments, the CSI-RS resource set configuration may include symbol assignment information that indicates to the SMR a set of symbols used for the SMR CSI-RS beam sweep. The symbols to be used may be contiguously allocated, or may be non-continuously allocated with a fixed gap within the indicated slots. In some instances, this is accomplished using a start and length indicator (SLIV) that indicates a starting symbol within the symbols and a length in terms of the contiguous symbols or in terms of non-contiguous symbols according to a fixed gap. Note that in embodiments using SLIV, the number of the one or more contiguous slots is not strictly necessary, and thus may not have been included in the CSI-RS resource set configuration transmitted to the SMR.

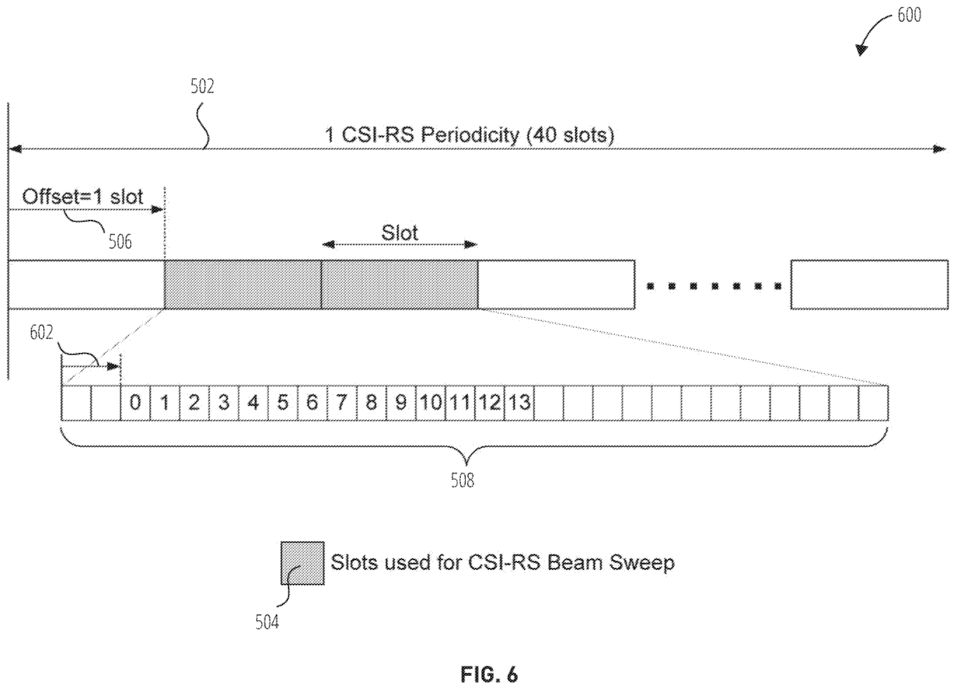

FIG. 6 provides a diagram 600 for SLIV use to identify one or more symbols of one or more contiguous slots 504 within a period of a CSI-RS periodicity to use to perform an SMR CSI-RS beam sweep, according to an embodiment. The diagram 600 is a modified version of the diagram 500. The SLIV received in the CSI-RS resource set configuration may indicate a symbol offset 602 of two symbols, as illustrated. That SLIV may also indicate that the following 14 symbols should be used for sending corresponding CSI-RS resources during a CSI-RS beam sweep. Accordingly, the SMR uses the third through the 16th of the symbols 508 to perform a CSI-RS beam sweep using 14 corresponding CSI-RS resources (indexed in FIG. 6 from zero to 13), with each such CSI-RS resource using an associated DL beam direction.

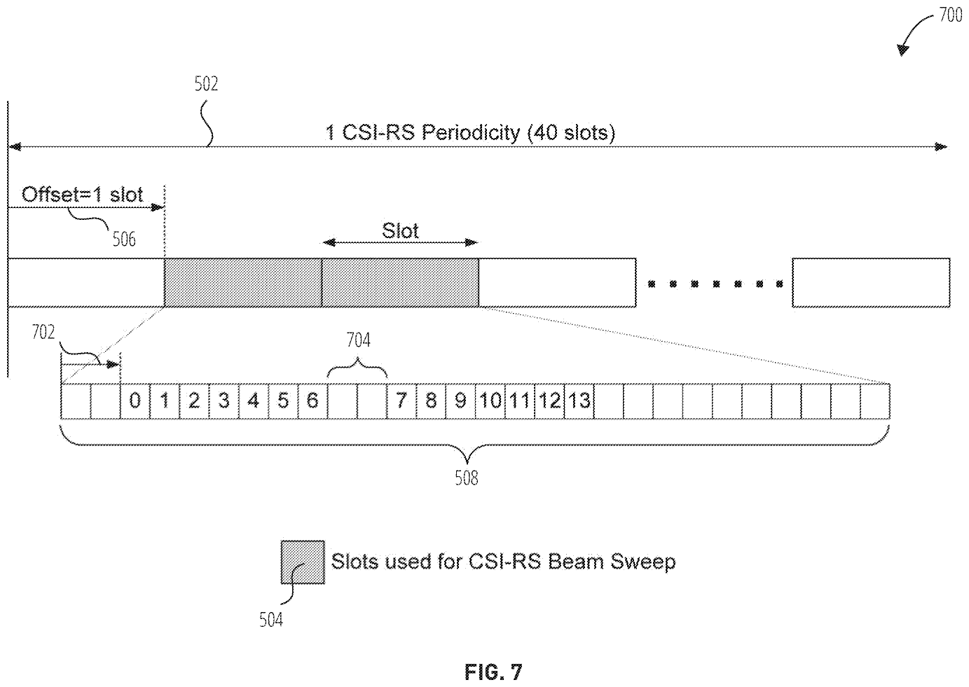

FIG. 7 provides a diagram 700 for SLIV use to identify one or more symbols of one or more contiguous slots 504 within a period of a CSI-RS periodicity to use to perform an SMR CSI-RS beam sweep, according to an embodiment. The diagram 700 is a modified version of the diagram 500. The SLIV received in the CSI-RS resource set configuration may indicate a symbol offset 702 of two symbols, as illustrated. That SLIV may also indicate that the following 7 symbols should be used for sending corresponding CSI-RS resources during a CSI-RS beam sweep, followed by a fixed gap 704 of two symbols, followed by seven more symbols used for CSI-RS resources during the SMR CSI-RS beam sweep. Accordingly, assuming that the 28 symbols 508 are enumerated from left to right, the SMR uses the 3rd through the 9th of the symbols 508 and the 12th through the 18th of the symbols 508 to perform a CSI-RS beam sweep for 14 corresponding CSI-RS resources (indexed in FIG. 7 from Oto 13), with each such CSI-RS resource using an associated DL beam direction.

In some embodiments, the CSI-RS resource set configuration may include a bitmap corresponding to the symbols of the one or more contiguous slots that is used to indicate symbol locations of one or more of the symbols within the one or more contiguous slots that are to be used to transmit CSI-RS resources during the SMR CSI-RS beam sweep.

In some cases, the bitmap includes a bit for all the symbols of the one or more contiguous slots and indicates the one or more symbols used to perform the SMR CSI-RS beam sweep from among all the symbols of the one or more contiguous slots.

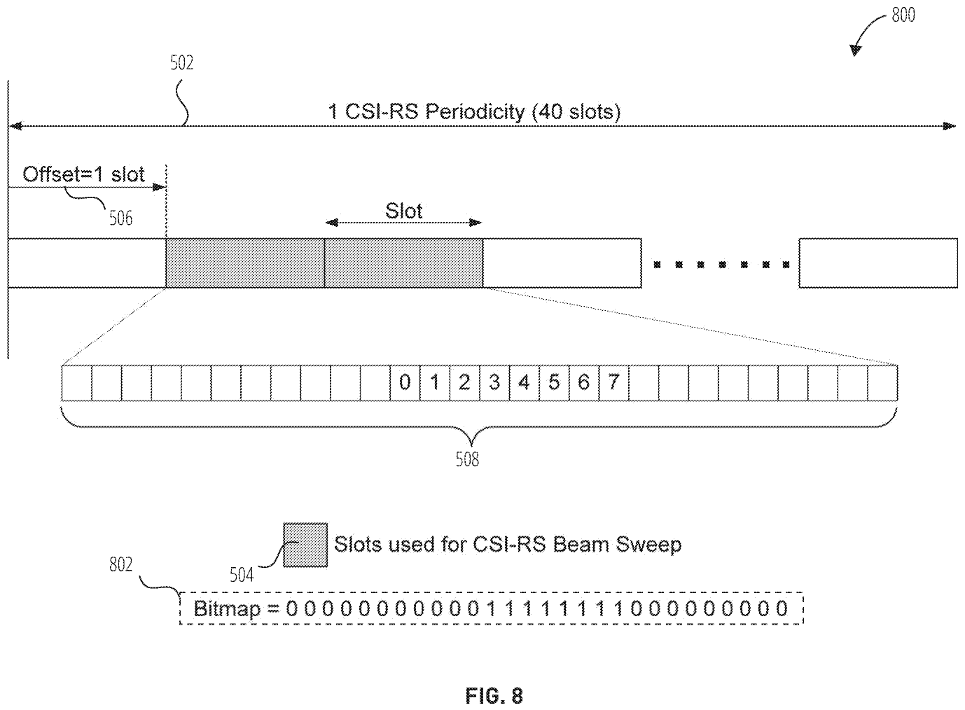

FIG. 8 illustrates a diagram 800 for the use of a bitmap 802 to indicate symbol locations for one or more of symbols 508 within one or more contiguous slots 504 that are to be used to transmit CSI-RS resources during a SMR CSI-RS beam sweep, according to an embodiment. The diagram 800 is a modified version of the diagram 500. The bitmap 802 indicates that, of the 28 symbols 508 corresponding to the two contiguous slots 504, the 12th through the 19th (assuming that the 28 symbols 508 are enumerated from left to right) of the symbols 508 should be used to transmit CSI-RS resources during a CSI-RS beam sweep. Accordingly, the SMR uses the 12th through the 19th symbols to perform the CSI-RS beam sweep using eight corresponding CSI-RS resources (indexed in FIG. 6 from 0 to 7), with each such CSI-RS resource using an associated DL beam direction.

Note that in embodiments, such as that illustrated in FIG. 8, where the size of the bitmap is coextensive with the size of the two contiguous slots 504 (when considered in a symbol-wise fashion, e.g., the bitmap 802 covers 28 symbols, which is the same number of symbols in the two contiguous slots 504), it may be that the CSI-RS resource set configuration does not include an explicit indication of the number of slots. The SMR may infer, when it is provided a bitmap and is not provided an explicit indication of the number of slots, that the number of the one or more contiguous slots is represented by reference according to the number of symbols for the one or more contiguous slots given by the bitmap.

In some cases, the bitmap includes a number of bits equal to a slot symbol length (e.g., 14 bits). This bitmap may act to indicates symbols, for each of the one or more contiguous slots, that comprise the one or more symbols used to perform the SMR CSI-RS beam sweep (e.g., indicates a bit pattern that is repeatedly applied to each of the one or more contiguous slots).

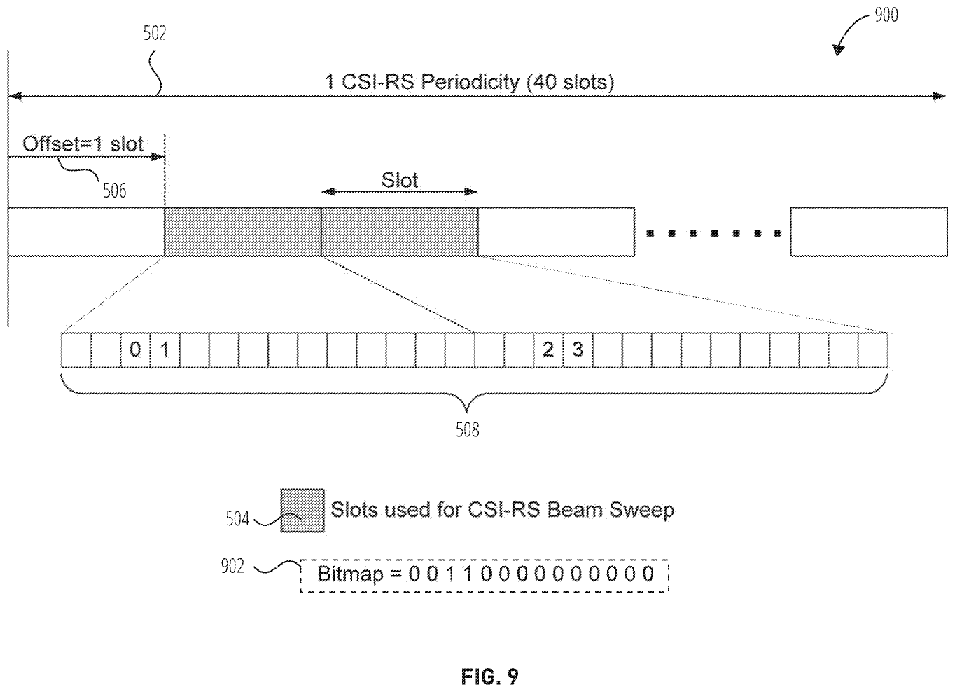

FIG. 9 illustrates a diagram 900 for the use of a bitmap 902 to indicate symbol locations for one or more of symbols 508 within one or more contiguous slots 504 that are to be used to transmit CSI-RS resources during a SMR CSI-RS beam sweep, according to an embodiment. The diagram 900 is a modified version of the diagram 500. The bitmap 902 differs from the bitmap 802 in that it only represents 14 symbols (equal to the number of symbols of a single slot). In such embodiments, the SMR may use an indicated number of slots from the CSI-RS resource set configuration to determine the number of the two contiguous slots 504 (e.g., two). Then, for each of the two contiguous slots 504, the bitmap 902 is applied (on a slot-wise basis) to identify symbols within each such slot 504 that are used to transmit CSI-RS resources of the SMR CSI-RS beam sweep.

In the example of FIG. 9, the bitmap 902 indicates that, of the 14 symbols in each of the two contiguous slots 504, the third and fourth symbols should be used to transmit CSI-RS resources during a CSI-RS beam sweep. Accordingly, the SMR uses the third and fourth symbols from each of the two contiguous slots 504 to perform the CI-RS beam sweep using four corresponding CSI-RS resources (indexed in FIG. 6 from 0 to 3), with each such CSI-RS resource using an associated DL beam direction.

In some embodiments, once the one or more contiguous slots are identified (e.g., using the CSI-RS periodicity, the offset, and the indication of the number of the one or more contiguous slots), the SMR may use all symbols of the one or more contiguous slots to transmit CSI-RS resources during an SMR CSI-RS beam sweep.

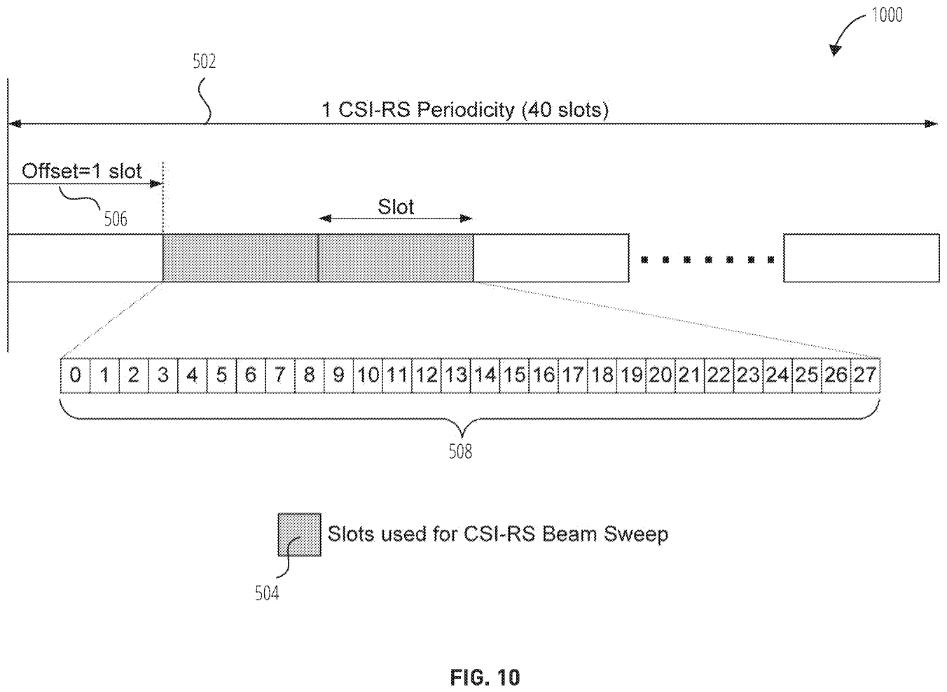

FIG. 10 illustrates a diagram 1000 showing the use of all symbols of one or more contiguous slots 504 to transmit CSI-RS resources during an SMR CSI-RS beam sweep, according to an embodiment. The diagram 1000 is a modified version of the diagram 500.

In the example of FIG. 10, the SMR has identified the two contiguous slots 504 within the period 502 using the CSI-RS periodicity and the offset 506 from the CSI-RS resource set configuration, in the manner described above. Then, the SMR uses every symbol of the two contiguous slots 504 to perform the CSI-RS beam sweep. This corresponding to the use of 28 CSI-RS resources corresponding to those 28 symbols 508 (indexed in FIG. 6 from 0 to 27), with each such CSI-RS resource using an associated DL beam direction.

In some embodiments, the CSI-RS resource set configuration sent to the SMR may also include a CSI-RS resource ID (e.g., an NZP-CSI-RS resource ID) for each resource of the CSI-RS resource set that corresponds a symbol and that is transmitted on that symbol. This CSI-RS resource ID may correspond to (e.g., be the same as) the “indexes” described above.

In some embodiments, the CSI-RS resource set configuration sent to the SMR may also include QCL information for each CSI-RS resource in the CSI-RS resource set.

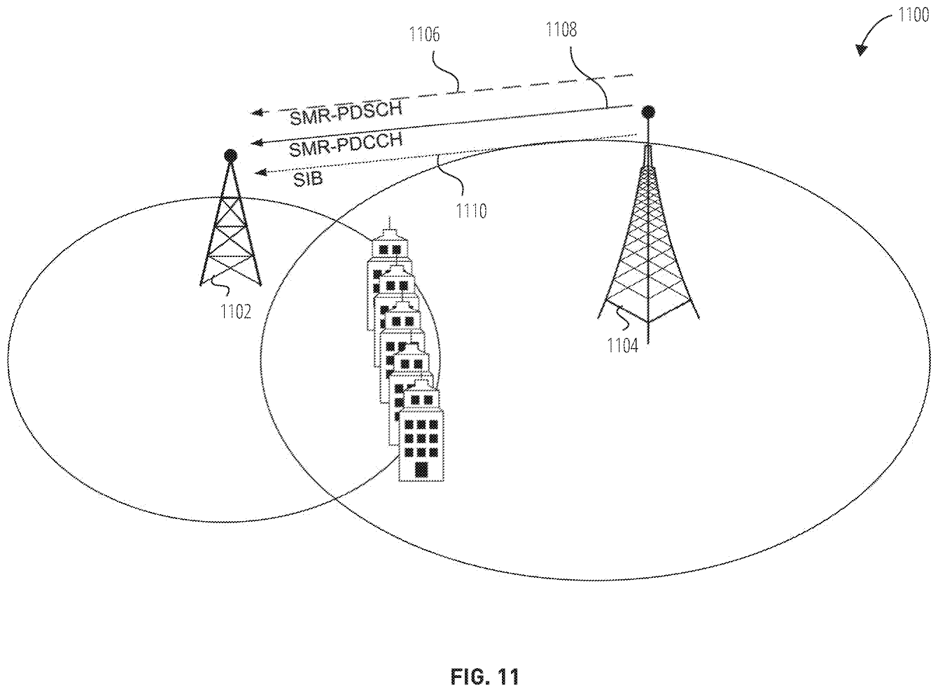

FIG. 11 illustrates a diagram 1100 showing the delivery of SMR control information, according to embodiments disclosed herein. As illustrated, it may be that the base station 1104 sends SMR control information to the SMR 1102 on one or more of an SMR-PDSCH 1106, an SMR-PDCCH 1108, and/or an SIB 1110 (and/or multiples of either/all of these). One or more such SMR-PDSCHs, SMR-PDCCHs, and/or SIBs may be used to deliver SMR control information in a variety of different possible ways.

In a first SMR control information delivery mechanism, high-layer signaling may be use used. Delivery of SMR control information from the base station to the SMR via high-layer signaling may be periodic in nature.

In some cases, high-layer signaling in the form of an SIB transmitted from the base station to the SMR may be used to deliver SMR control information. SMR control information in such an SIB may indicate, to the SMR, SSB positions of SSBs of an SSB burst set to be used by the SMR for an SMR SSB beam sweep. For example, in the case where a system uses 31 SSBs, and where SSBs 0 through 23 are to be used in a first SSB burst set beam sweep by a base station and SSBs 24 through 31 are to be used in a second SSB burst set for a beam sweep by an SMR, the SIB may include a ssb-PositionsInBurst information element sent by the SMR indicating
00000000000000000000000011111111
corresponding to the second SSB burst set for the SMR.

This SIB may accordingly differ from an SIB transmitted by the base station for any gNB-UE (which may configure the gNB-UE to use a first SSB burst set instead).

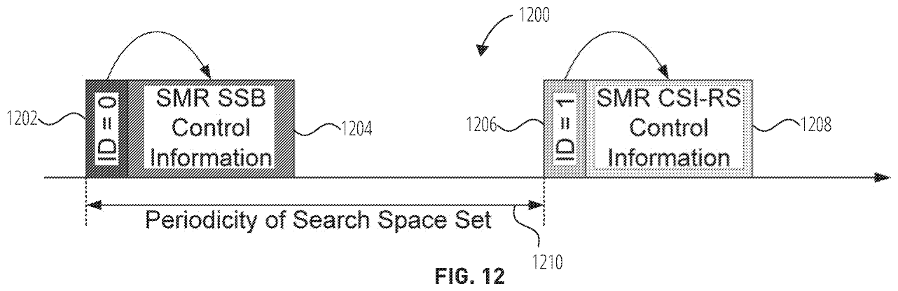

In some cases, high-layer signaling as scheduled by downlink control information (DCI) is used. FIG. 12 illustrates a diagram 1200 showing a delivery of SMR control information using high-layer signaling (e.g., radio resource control (RRC) signaling) as scheduled by a DCI, according to an embodiment. Discussion of FIG. 12 will refer back to the contents illustrated in FIG. 11.

According to the diagram 1200, the first DCI 1202 is sent by the base station 1104 to the SMR 1102 in an SMR-PDCCH (such as the SMR-PDCCH 1108). This first DCI 1202 schedules reception of a first SMR-PDSCH 1204 having a first portion of SMR control information. As illustrated, the first DCI 1202 may further include a one-bit identifier that indicates whether the first SMR-PDSCH 1204 will contain SMR SSB control information (SMR control information for performing an SMR SSB beam sweep, as described herein) or SMR CSI-RS control information (SMR control information for performing a CSI-RS beam sweep, as described herein). By way of example, in the first DCI 1202, this one-bit identifier is set to zero, which corresponds to the reception of SMR SSB control information in the first portion of the SMR control information found in the first SMR-PDSCH 1204 (as indicated in the illustration).

Further, the second DCI 1206 is sent by the base station 1104 to the SMR 1102 in an SMR-PDCCH (such as the SMR-PDCCH 1108). This second DCI 1206 schedules reception of a second SMR-PDSCH 1208 having a second portion of SMR control information. As illustrated, the second DCI 1206 may further include a one-bit identifier that indicates whether the second DCI 1206 will contain SMR SSB control information or SMR CSI-RS control information. By way of example, in the second DCI 1206, this one-bit identifier is set to one, which corresponds to the reception of SMR CSI-RS control information in the second portion of the SMR control information found in the second SMR-PDSCH 1208 (as indicated in the illustration).

Each of the first DCI 1202 and the second DCI 1206 may be sent by the base station 1104 according to a search space set periodicity 1210 for a search space set that corresponds to the reception of DCI for scheduling high-layer signaling that conveys SMR control information for the SMR 1102.

In a second SMR control information delivery mechanism, a DCI is itself used to communicate SMR control information from a base station to an SMR. In such cases, a new DCI format may be used for the DCI, where the use of the new DCI format indicates that the DCI carries SMR control information. This new DCI format may be identified by via an associated, dedicated radio network temporary identifier (RNTI) that is used to scramble cyclic redundancy check (CRC) bits of the new DCI format.

In some cases, it may be that multiple RNTIs are used for identifying DCI of this new format. In such cases, it may be that the use of a first such RNTI indicates to the SMR that the received DCI carries a first portion of SMR control information that is for an SMR SSB beam sweep, and a second such RNTI indicates to the SMR that a received DCI instead carries a second portion of SMR control information that is for an SMR CSI-RS beam sweep.

In other cases, it may be instead that the same RNTI is used for both a DCI carrying a first portion of SMR control information for an SMR SSB beam sweep and a DCI carrying a second portion of SMR control information for an SMR CSI-RS beam sweep. In such cases, the type of SMR control information included in the DCI may be indicated to the SMR 1102 in other ways.

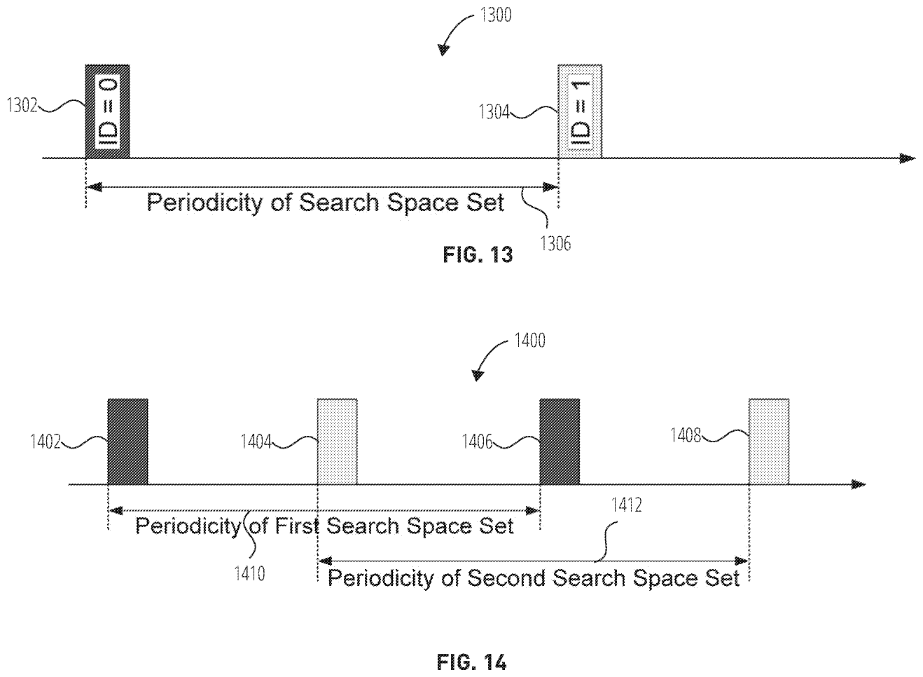

FIG. 13 illustrates a diagram 1300 showing delivery of SMR control information using DCI, according to an embodiment. The diagram 1300 includes the first DCI 1302 and the second DCI 1304. The CRCs of each of the first DCI 1302 and the second DCI 1304 are both scrambled by the (same) RNTI to indicates that (each) DCI includes SMR control information.

As illustrated, the first DCI 1302 includes a one-bit identifier that is set to be zero. This value may indicate to the SMR 1102 that a first portion of SMR control information in the first DCI 1302 is for an SMR SSB beam sweep. Further, as illustrated, the second DCI 1304 includes a one-bit identifier that is set to be one. This value may indicate to the SMR 1102 that a second portion of the SMR control information in the second DCI 1304 is for an SMR CSI-RS beam sweep.

Each of the first DCI 1302 and the second DCI 1304 may be sent by the base station 1104 according to a search space set periodicity 1306 for a search space set that corresponds to the reception at the SMR 1102 of DCI having SMR control information.

FIG. 14 illustrates a diagram 1400 showing delivery of SMR control information using DCI, according to an embodiment. The diagram 1400 includes the first DCI 1402, the second DCI 1404, the third DCI 1406, and the fourth DCI 1408, which have each been scrambled by the (same) RNTI that indicates that (each) DCI includes SMR control information.

In the embodiment of FIG. 14, DCI having different types of SMR control information are differentiated according to the search space set where they are detected. For example, as illustrated, the first DCI 1402 and the third DCI 1406 have been sent to the SMR 1102 according to a first search space set (e.g., that uses the periodicity 1410). Because the first DCI 1402 and the third DCI 1406 are received according to the first search space set (e.g., periodicity 1410), the SMR understands that each of the first DCI 1402 and the third DCI 1406 contain SMR SSB control information.

Further, as illustrated, the second DCI 1404 and the fourth DCI 1408 are received according to a second search space set (e.g., that uses the periodicity 1412). Because the second DCI 1404 and the fourth DCI 1408 are received according to the second search space set (e.g., periodicity 1412), the SMR understands that each of the second DCI 1404 and the fourth DCI 1408 contain SMR CSI-RS control information.

It is contemplated that the use of one-bit identifiers (e.g., as described in relation to FIG. 13) and/or separate search space set associations (e.g., as described in relation to FIG. 14) could also be used in cases where the DCI schedules high-layer signaling that actually contains the configuration, as described in relation to FIG. 12. In such cases, the one-bit identifier of the DCI or the search space periodicity used to receive the DCI (as the case may be) accordingly identifies the type of the portion of the SMR control information contained in the high-layer signaling scheduled by the DCI. Indeed, the discussion of FIG. 12 describes this use case with the one-bit identifier expressly.

As described in relation to FIG. 11 through FIG. 14, DCI may be used to either schedule signaling for the SMR that includes SMR control information or itself be used to communicate SMR control information to the SMR. In either case, details regarding control resources set (CORESET) configurations and search space set configurations for use by the SMR to perform the appropriate PDCCH monitoring for the reception of such DCI are contemplated.

An SMR may use a CORESET configuration to use to perform PDCCH monitoring. Some or all of the CORESET configuration may be provided to the SMR by a base station. Alternatively or additionally, some or all of the CORESET configuration may be as pre-defined in a specification for the wireless communication system and/or pre-configured to one or both of the SMR and the base station, as necessary.

As used herein, a parameter that is “pre-defined” is a parameter that is set/known/used according to a definition for a wireless communication system for such embodiments (e.g., as defined in a specification defining the behavior of such wireless communications systems). As used herein, a parameter that is “pre-configured” is a parameter that is provided to an entity of a wireless communication system (e.g., a base station, an SMR, or a UE) prior to an immediate need to use the parameter for the related process(es) discussed herein.

The CORESET configuration may define a number of consecutive symbols for the CORESET. In some cases, this value is provided to the SMR by the base station. In some cases, this value may be pre-configured at the SMR and/or the base station. Further, this value may additionally and/or alternatively be pre-defined according to a specification for the wireless communication system. It is contemplated that in some embodiments, a number of consecutive symbols may be equal to a half-slot or a full slot (e.g., 7 symbols or 14 symbols). This may reduce the number of resource blocks (RBs) used in the frequency domain for the CORESET, which may allow power boosting at the base station for SMR control information transmission (thereby improving detection performance at the SMR).

The CORESET configuration may define a set of RBs for the CORESET.

The CORESET configuration may define control channel element (CCE) to resource element group (REG) mapping parameters. In some cases, one of these mapping parameters may specify to use non-interleaved CCE to REG mapping, and this may be according to a pre-definition in a specification for the wireless communication system.

The CORESET configuration may define an antenna port quasi co-location (QCL) parameter for the CORESET. In some cases, the antenna port QCL parameter may specify that a most recent SSB is to be used as a QCL source.

An SMR may use a search space set configuration to perform PDCCH monitoring. Some or all of the search space set configuration may be provided to the SMR by a base station. Alternatively or additionally, some or all of the search space set configuration may be as pre-defined in a specification for the wireless communication system, and/or pre-configured to one or both of the SMR and the base station, as necessary).

The search space set configuration may define a PDCCH monitoring periodicity. In some cases, the PDCCH monitoring periodicity is pre-configured to the SMR and/or the base station. In some cases, the PDCCH monitoring periodicity may be pre-defined at the SMR and/or the base station according to a specification for the wireless communication system (e.g., a value of 20 milliseconds may be defined per the specification and/or pre-configured to the SMR and/or the base station).

The search space configuration may define that a PDCCH monitoring occasion is limited to a number of first symbols of a slot (e.g., a first two or three symbols of a slot).

The search space configuration may define that a number of PDCCH candidates per CCE aggregation level (AL). In some cases, the search space configuration may define that one or two candidates per CCE AL is allowed. This value may be pre-configured to the SMR and/or the base station, and/or may be used at the SMR and/or the base station as pre-defined by a specification for the wireless communication system. Further, it may be that the ALs themselves are limited to one or two ALs by the search space configuration. In some cases, these ALs may be AL8 and/or AL16, as defined in a specification for the wireless communication system.

In some embodiments, paging DCI between a base station and an SMR may be used to notify the SMR that there is updated SMR control information available to the SMR (e.g., as compared to prior SMR control information known to the SMR). In such cases, it may be that either or both of SMR SSB control information and/or SMR CSI-RS control information is updated relative to prior such information known to the SMR. In response to receiving such a paging DCI, the SMR determines that updated SMR control information is available, and accordingly performs PDCCH monitoring for SMR SSB control information and/or SMR CSI-RS control information (e.g., using methods discussed herein). It may be that in some (but not necessarily all) cases, this PDCCH monitoring is only performed by the SMR in response to the reception of such a paging DCI (in order to save power).

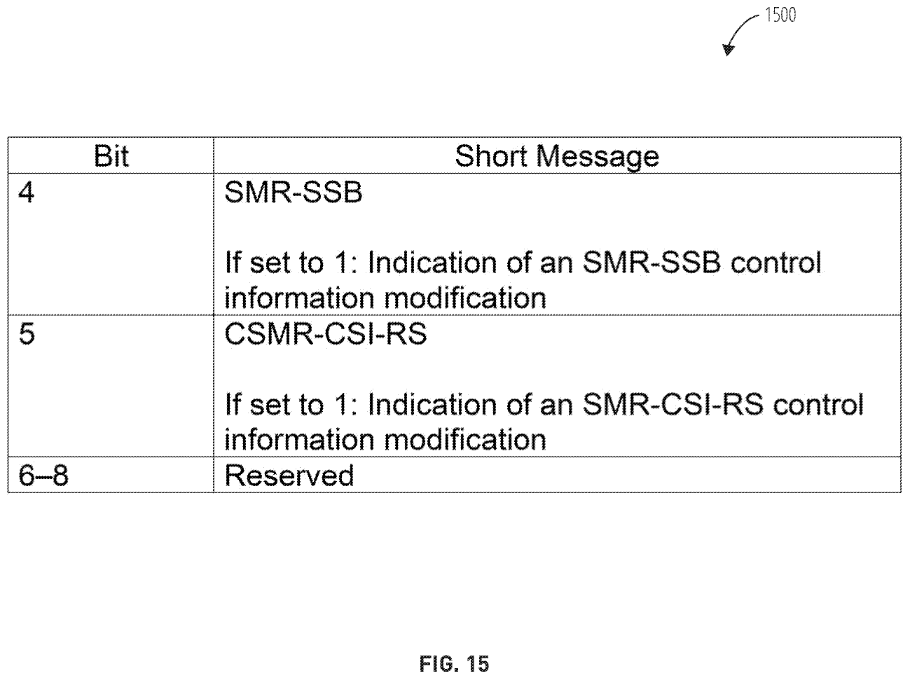

Various arrangements of such paging DCI are now discussed. In a first example of this paging DCI, a pair of reserved bits from a short message field in DCI format 1_0 may be repurposed to indicate a updated/modified SMR control information availability to the SMR. FIG. 15 illustrates a table 1500 showing the repurposing of two reserved bits from a short message field in DCI format 1_0 to indicate modified SMR control information availability to an SMR, according to an embodiment. As illustrated, the fourth bit of the short message field of the DCI format 1_0 (which was previously reserved) may be used to indicate (e.g., when the value is set to be 1) that SMR SSB control information has been updated or modified. Further, as illustrated, the fifth bit of the short message field in the DCI format 1_0 (which was also previously reserved) may be used to indicate (e.g., when the value set to be 1) that SMR CSI-RS control information has been updated or modified.

In a second example of this paging DCI, it may be the case that paging DCI has CRC bits that are scrambled with a paging RNTI (P-RNTI). There may be five reserved bits in such a paging DCI. It may be that one or more of the five reserved bits in the DCI is repurposed to indicate whether the SMR control information (e.g., either or both of the SMR SSB control information and/or the SMR CSI-RS control information) has been updated or modified.

In a third example of this paging DCI, the paging DCI used to notify the SMR of updated SMR control information may have its CRC bits scrambled by a specified P-RNTI that is allocated to indicate that SMR control information has been updated. In some cases, this specified P-RNTI may be pre-configured to the base station and/or the SMR, and/or may be set as pre-defined in a specification for the wireless communication system. In some cases, this specified P-RNTI may be signaled from the base station to the SMR in an SIB. This P-RNTI may be the same across all SMR that operate with such a base station. The SMR is accordingly notified that updated SMR control information is available upon determining that this P-RNTI was used for the paging DCI.

In a fourth example of this paging DCI, it may be that the paging DCI is received in a dedicated search space set that is associated with an update of the SMR control information (e.g., a search space set that is used to send paging DCI when SMR control information is updated and/or modified). In some cases, this search space set may be a Type1 common search space (Type1-CSS). The use of the dedicated search space set may help to differentiate between paging DCI for SMR(s) and paging DCI for other devices (e.g., UE). The SMR is accordingly notified that updated SMR control information is available upon receiving the paging DCI in this dedicated search space set.

In some embodiments, an SMR may report SMR capability information to a base station. This may aid the base station to send, to the SMR, SMR configuration information that the SMR is capable of implementing (e.g., SMR SSB configuration information defining a SMR SSB beam sweep that the SMR is capable of performing, and/or SMR CSI-RS configuration information defining an SMR CSI-RS beam sweep that the SMR is capable of performing).

The SMR capability information may include a device type parameter. This device type parameter may indicate to the base station that the SMR is capable of performing SMR functions (to differentiate the SMR from, e.g., a UE).

The SMR capability information may include a maximum number of beams for DL transmission that the SMR is capable of using. This maximum number of beams for DL transmission parameter may aid the base station to only configure the SMR for beam sweeps that can be performed with that maximum number of beams. The a maximum number of beams for UL transmission parameter may also be included.

The SMR capability may include a maximum transmission power parameter. This maximum transmission power parameter may be given in the form of a power class indication for a power class of the SMR. In some cases, if no maximum transmission power parameter is given, the base station may default to treating the SMR as having a power class that is pre-defined in a specification for the wireless communication system. The maximum transmission power parameter allows the base station to appropriately set an Energy-Per-RE (EPRE) setting for SSB and/or CSI-RS transmission(s) by the SMR, such that PL calculations to determine SMR-UE power control are appropriately facilitated at any SMR-UEs, in the case that these signals are used at the SMR UEs as DL RSs for power control of PUSCH, PUCCH, SRS, beam management, beam failure detection (BFD), and/or cell selection, etc.

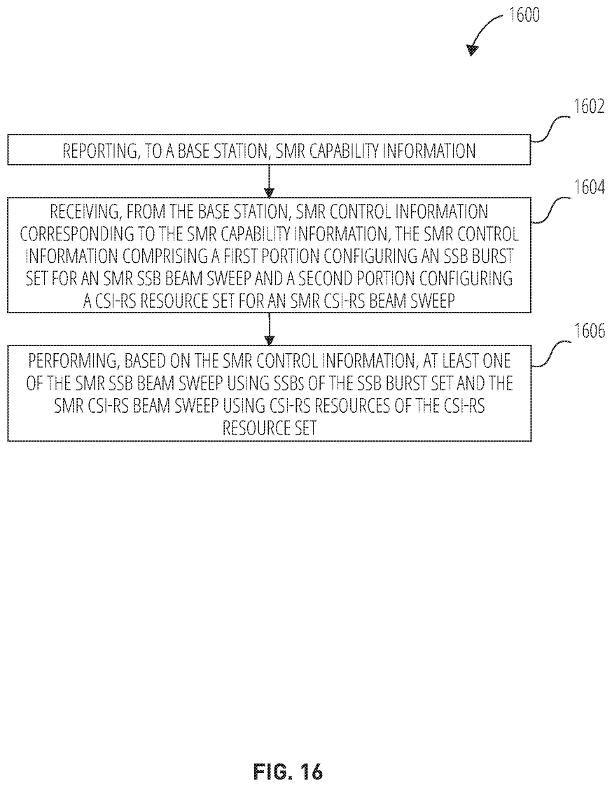

FIG. 16 illustrates a method of an SMR, according to an embodiment. The method 1600 includes reporting 1602, to a base station, SMR capability information.

The method 1600 further includes receiving 1604, from the base station, SMR control information corresponding to the SMR capability information, the SMR control information comprising a first portion configuring an SSB burst set for an SMR SSB beam sweep and a second portion configuring a CSI-RS resource set for an SMR CSI-RS beam sweep.

The method 1600 further includes performing 1606, based on the SMR control information, at least one of the SMR SSB beam sweep using SSBs of the SSB burst set and the SMR CSI-RS beam sweep using CSI-RS resources of the CSI-RS resource set.

In some embodiments of the method 1600, at least one of the first portion and the second portion is received in high-layer signaling on a PDSCH for the SMR.

In some embodiments of the method 1600, a first one of the first portion and the second portion is received in DCI of a first DCI format having CRC bits scrambled by a first RNTI that identifies that the first DCI format includes the first one of the first portion and the second portion. In some such embodiments, the first RNTI of the first DCI format is different than a second RNTI of a second DCI format used by the base station corresponding to a second one of the first portion and the second portion. In some such embodiments, the DCI comprises a one-bit identifier that indicates that the DCI includes the first one of the first portion and the second portion. In some such embodiments, the DCI is received in a first search space set that identifies the first one of the first portion and the second portion.

In some such embodiments, the method 1600 further includes performing PDCCH monitoring for the DCI according to a CORESET configuration that includes: a number of consecutive symbols for a CORESET; a set of RBs for the CORESET; CCE to REG mapping parameters for the CORESET; and an antenna port QCL parameter for the CORESET. In some of these cases, the number of consecutive symbols is a value of two or three that is one of pre-configured to the SMR and pre-defined for the SMR. In some of these cases, the number of consecutive symbols for the CORESET is one of seven symbols and fourteen symbols. In some of these cases, the CCE to REG mapping parameters are pre-defined to indicate for a use of non-interleaved CCE to REG mapping. In some of these cases, the antenna port QCL parameter is pre-defined to indicate that a most recent SSB is a QCL source.

In some such embodiments, the method 1600 further includes performing PDCCH monitoring for the DCI according to a search space set configuration that includes: a PDCCH monitoring periodicity; a PDCCH monitoring offset; and a number of PDCCH candidates per CCE AL. In some of these cases, the PDCCH monitoring periodicity is a value of 20 milliseconds that is one of pre-configured to the SMR and pre-defined for the SMR. In some of these cases, the search space set configuration further defines that a PDCCH monitoring occasion for the DCI is limited to a first two or first three symbols of a slot. In some of these cases, the number of PDCCH candidates per CCE AL is a value of one or two that is one of pre-configured to the SMR and pre-defined for the SMR.

In some embodiments of the method 1600, the performing, based on the SMR control information, one of the SMR SSB beam sweep and the SMR CSI-RS beam sweep comprises performing the SMR SSB beam sweep based on the first portion; and the method 1600 further comprises receiving, from the base station, based on the first portion, the SSB burst set for the SMR SSB beam sweep, wherein the SMR SSB beam sweep occurs within a period of an SMR SSB burst periodicity. In some such embodiments, the first portion indicates the SMR SSB burst periodicity.

In some such embodiments, the first portion includes an offset value; and the SSB burst set is received within the period according to the offset value. In some of these cases, the offset value is given in units of half radio frames. In some of these cases, the offset value is given in units of a length of a maximum number of SSBs that are supported when using a current subcarrier spacing.

In some such embodiments, the first portion comprises a bitmap indicating one or more SSB positions within the period, each of the one or more SSB positions corresponding to one of the one or more SSBs of the SSB burst set; and the one or more SSBs are received within the period during the one or more SSB positions. In some such embodiments, the first portion comprises a first SIB that differs from a second SIB transmitted by the base station by indicating SSB positions within the period; and the SSBs of the SSB burst set use the SSB positions during the SMR SSB beam sweep.

In some embodiments of the method 1600, the performing, based on the SMR control information, one of the SMR SSB beam sweep and the SMR CSI-RS beam sweep comprises performing the SMR CSI-RS beam sweep based on the second portion; and the method 1600 further comprises identifying, based on the second portion, one or more symbols of one or more contiguous slots within a period of an SMR CSI-RS periodicity to use to perform the SMR CSI-RS beam sweep.

In some such embodiments, the second portion further comprises a start and length indicator (SLIV) indicating the one or more symbols used to perform the SMR CSI-RS beam sweep. In some of these cases, the one or more symbols used to perform the SMR CSI-RS beam sweep are contiguous within the one or more contiguous slots. In some of these cases, the one or more symbols used to perform the SMR CSI-RS beam sweep comprises a plurality of symbols that are not contiguous in time within the one or more contiguous slots by a fixed gap.

In some such embodiments, the second portion further comprises a bitmap having a bit for all the symbols of the one or more contiguous slots, the bitmap indicating the one or more symbols used to perform the SMR CSI-RS beam sweep from among all the symbols of the one or more contiguous slots. In some such embodiments, the second portion further indicates a number of the one or more contiguous slots; and further comprises a bitmap having a number of bits equal to a number of symbols in a slot, the bitmap indicating the symbols, for each of the one or more contiguous slots, that comprise the one or more symbols used to perform the SMR CSI-RS beam sweep. In some such embodiments, the second portion further indicates a number of the one or more contiguous slots; and the one or more symbols used to perform the SMR CSI-RS beam sweep includes all symbols of the one or more contiguous slots.

In some embodiments, the method 1600 further includes receiving, from the base station, paging DCI indicating that the SMR control information is updated versus prior SMR control information previously provided to the SMR. In some such embodiments, the paging DCI is of DCI Format 1_0 having a short message field that is used to indicate that the SMR control information is updated by using a reserved bit of the short message field. In some such embodiments, the paging DCI is of DCI Format 1_0 with CRC bits scrambled by a P-RNTI, and that indicates that the SMR control information is updated using a reserved bit of DCI Format 1_0. In some such embodiments, the paging DCI is of DCI Format 1_0 and indicates that the SMR control information is updated because it is scrambled by a dedicated RNTI that is allocated to indicate that the SMR control information is updated. In some such embodiments, the paging DCI indicates that the SMR control information is updated because it is received in a dedicated search space set that is allocated for indicating that the SMR control information is updated.

In some embodiments of the method 1600, the SMR capability information comprises one or more of: a device type parameter; one of a maximum number of uplink beams parameter and a maximum number of downlink beams parameter; and a maximum transmission power parameter. In some such embodiments, the device type parameter indicates to the base station that the SMR is capable of performing SMR functionality. In some such embodiments, the maximum transmission power parameter indicates a power class of the SMR.

Embodiments contemplated herein include an apparatus comprising means to perform one or more elements of the method 1600. This apparatus may be, for example, an apparatus of an SRM (such as an SMR 1902, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of an SMR (such as a memory 1906 of an SMR 1902, as described herein).

Embodiments contemplated herein include an apparatus comprising logic, modules, or circuitry to perform one or more elements of the method 1600. This apparatus may be, for example, an apparatus of an SMR (such as an SMR 1902, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of an SMR (such as an SMR 1902, as described herein).

Embodiments contemplated herein include a signal as described in or related to one or more elements of the method 1600.

Embodiments contemplated herein include a computer program or computer program product comprising instructions, wherein execution of the program by a processor is to cause the processor to carry out one or more elements of the method 1600. The processor may be a processor of an SMR (such as a processor(s) 1904 of an SMR 1902, as described herein). These instructions may be, for example, located in the processor and/or on a memory of the SMR (such as a memory 1906 of an SMR 1902, as described herein).

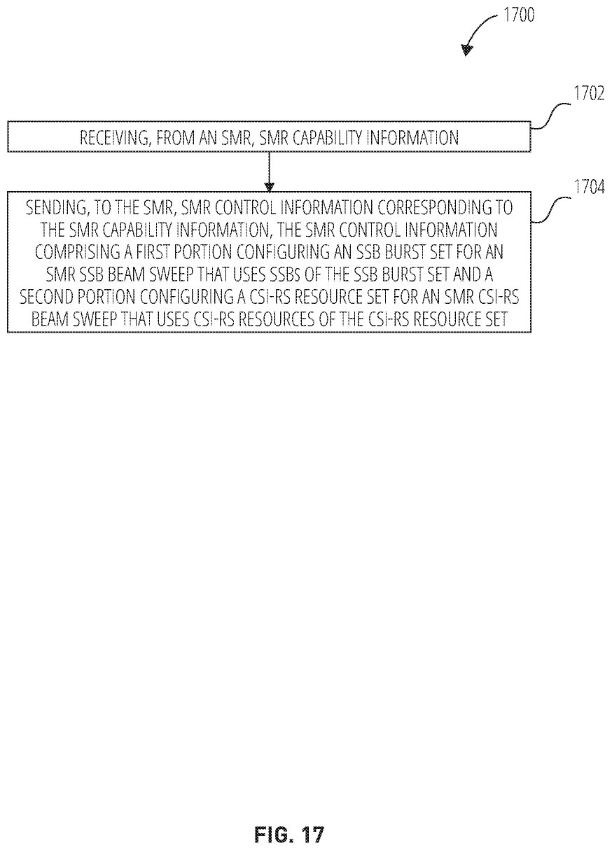

FIG. 17 illustrates a method 1700 of a base station, according to an embodiment. The method 1700 includes receiving 1702, from an SMR, SMR capability information.

The method 1700 further includes sending 1704, to the SMR, SMR control information corresponding to the SMR capability information, the SMR control information comprising a first portion configuring a SSB burst set for an SMR SSB beam sweep that uses SSBs of the SSB burst set and a second portion configuring a CSI-RS resource set for an SMR CSI-RS beam sweep that uses CSI-RS resources of the CSI-RS resource set.

In some embodiments, of the method 1700, at least one of the first portion and the second portion is sent in high-layer signaling on a PDSCH for the SMR.

In some embodiments of the method 1700, a first one of the first portion and the second portion is sent in DCI of a first DCI format having CRC bits scrambled by a first RNTI that identifies that the first DCI format includes the first one of the first portion and the second portion. In some such embodiments, the first RNTI of the first DCI format is different than a second RNTI of a second DCI format used by the base station corresponding to a second one of the first portion and the second portion. In some such embodiments, the DCI comprises a one-bit identifier that indicates that the DCI includes the first one of the first portion and the second portion. In some such embodiments, the DCI is sent in a first search space set that identifies the first one of the first portion and the second portion.

In some such embodiments, the DCI is sent according to a CORESET configuration that defines: a number of consecutive symbols for a CORESET; a set of RBs for the CORESET; CCE to REG mapping parameters for the CORESET; and an antenna port QCL parameter for the CORESET. In some of these cases, the number of consecutive symbols is a value of two or three that is one of pre-configured to the base station and pre-defined for the base station. In some of these cases, the number of consecutive symbols for the CORESET is one of seven symbols and fourteen symbols. In some of these cases, the CCE to REG mapping parameters are pre-defined to indicate for a use of non-interleaved CCE to REG mapping. In some of these cases, the antenna port QCL parameter is pre-defined to indicate that a most recent SSB is a QCL source.

In some such embodiments, the DCI is sent according to a search space set configuration that defines: a PDCCH monitoring periodicity; a PDCCH monitoring offset; and a number of PDCCH candidates per CCE AL. In some such cases, the PDCCH monitoring periodicity is a value of 20 milliseconds that is one of pre-configured to the base station and pre-defined for the base station. In some such cases, the search space set configuration further defines that a PDCCH monitoring occasion for the DCI is limited to a first two or first three symbols of a slot. In some such cases, the number of PDCCH candidates per CCE AL is a value of one or two that is one of pre-configured to the base station and pre-defined for the base station.

In some embodiments, the method 1700 further includes sending, to the SMR, based on the first portion, the SSB burst set for the SMR SSB beam sweep, wherein the SMR SSB beam sweep occurs within a period of an SMR SSB burst periodicity. In some such embodiments, the first portion indicates the SMR SSB burst periodicity.

In some such embodiments, the first portion includes an offset value; and the SSB burst set is sent within the period according to the offset value. In some of these cases, the offset value is given in units of half radio frames. In some of these cases, the offset value is given in units of a length of a maximum number of SSBs that are supported when using a current subcarrier spacing.

In some such embodiments, the first portion comprises a bitmap indicating one or more SSB positions within the period, each of the one or more SSB positions corresponding to one of the one or more SSBs of the SSB burst set; and the one or more SSBs are sent within the period during the one or more SSB positions. In some such embodiments, the first portion comprises a first SIB that differs from a second SIB transmitted by the base station by indicating SSB positions within the period; and the SSBs of the SSB burst set use the SSB positions during the SMR SSB beam sweep.

In some embodiments, of the method 1700, the second portion identifies one or more symbols of one or more contiguous slots within a period of an SMR CSI-RS periodicity to use to perform the SMR CSI-RS beam sweep.

In some such embodiments, the second portion further comprises an SLIV indicating the one or more symbols used to perform the SMR CSI-RS beam sweep. In some of these cases, the one or more symbols used to perform the SMR CSI-RS beam sweep are contiguous within the one or more contiguous slots. In some of these cases, the one or more symbols used to perform the SMR CSI-RS beam sweep comprises a plurality of symbols that are not contiguous in time within the one or more contiguous slots by a fixed gap.

In some such embodiments, the second portion further comprises a bitmap having a bit for all the symbols of the one or more contiguous slots, the bitmap indicating the one or more symbols used to perform the SMR CSI-RS beam sweep from among all the symbols of the one or more contiguous slots. In some such embodiments, the second portion further indicates a number of the one or more contiguous slots; and further comprises a bitmap having a number of bits equal to a number of symbols in a slot, the bitmap indicating the symbols, for each of the one or more contiguous slots, that comprise the one or more symbols used to perform the SMR CSI-RS beam sweep. In some such embodiments, the second portion further indicates a number of the one or more contiguous slots; and the one or more symbols used to perform the SMR CSI-RS beam sweep includes all symbols of the one or more contiguous slots.

In some embodiments, the method 1700 further includes sending, to the SMR, paging DCI indicating that the SMR control information is updated versus prior SMR control information previously provided to the SMR. In some such embodiments, the paging DCI is of DCI Format 1_0 having a short message field that is used to indicate that the SMR control information is updated by using a reserved bit of the short message field. In some such embodiments, the paging DCI is of DCI Format 1_0 with CRC bits scrambled by a P-RNTI, and that indicates that the SMR control information is updated using a reserved bit of DCI Format 1_0. In some such embodiments, the paging DCI is of DCI Format 1_0 and indicates that the SMR control information is updated because it is scrambled by a dedicated RNTI that is allocated to indicate that the SMR control information is updated. In some such embodiments, the paging DCI indicates that the SMR control information is updated because it is sent in a dedicated search space set that is allocated for indicating that the SMR control information is updated.

In some embodiments of the method 1700, the SMR capability information comprises one or more of: a device type parameter; one of a maximum number of uplink beams parameter and a maximum number of downlink beams parameter; and a maximum transmission power parameter. In some such embodiments, the device type parameter indicates to the base station that the SMR is capable of performing SMR functionality. In some such embodiments, the maximum transmission power parameter indicates a power class of the SMR.

Embodiments contemplated herein include an apparatus comprising means to perform one or more elements of the method 1700. This apparatus may be, for example, an apparatus of a base station (such as a base station 1918 that is a base station, as described herein).

Embodiments contemplated herein include one or more non-transitory computer-readable media comprising instructions to cause an electronic device, upon execution of the instructions by one or more processors of the electronic device, to perform one or more elements of the method 1700. This non-transitory computer-readable media may be, for example, a memory of a base station (such as a memory 1922 of a base station 1918 that is a base station, as described herein).

Embodiments contemplated herein include an apparatus comprising logic, modules, or circuitry to perform one or more elements of the method 1700. This apparatus may be, for example, an apparatus of a base station (such as a base station 1918 that is a base station, as described herein).

Embodiments contemplated herein include an apparatus comprising: one or more processors and one or more computer-readable media comprising instructions that, when executed by the one or more processors, cause the one or more processors to perform one or more elements of the method 1700. This apparatus may be, for example, an apparatus of a base station (such as a base station 1918 that is a base station, as described herein).

Embodiments contemplated herein include a signal as described in or related to one or more elements of the method 1700.

Embodiments contemplated herein include a computer program or computer program product comprising instructions, wherein execution of the program by a processing element is to cause the processing element to carry out one or more elements of the method 1700. The processor may be a processor of a base station (such as a processor(s) 1920 of a base station 1918 that is a base station, as described herein). These instructions may be, for example, located in the processor and/or on a memory of the base station (such as a memory 1922 of a base station 1918 that is a base station, as described herein).

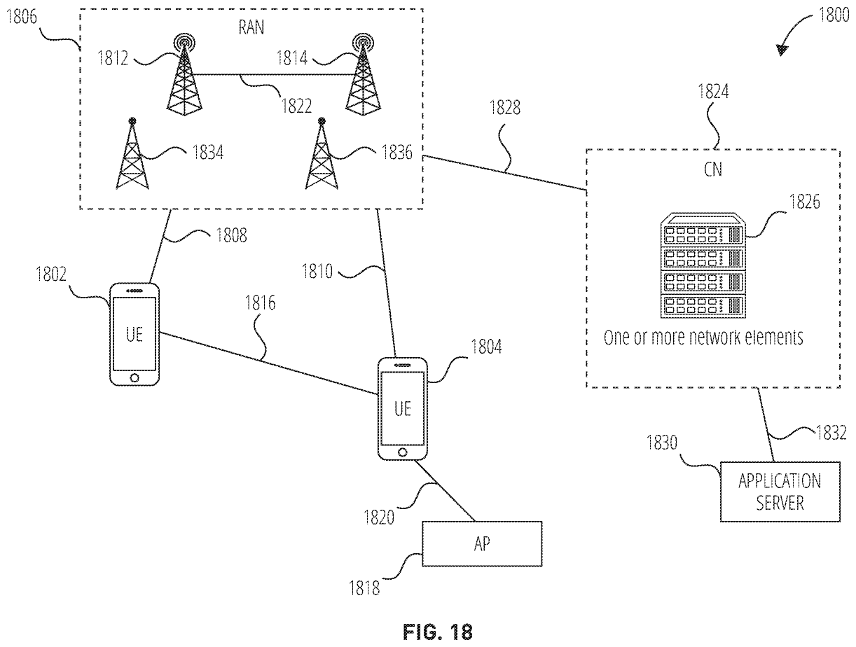

FIG. 18 illustrates an example architecture of a wireless communication system 1800, according to embodiments disclosed herein. The following description is provided for an example wireless communication system 1800 that operates in conjunction with the LTE system standards and/or 5G or NR system standards as provided by 3GPP technical specifications.

As shown by FIG. 18, the wireless communication system 1800 includes UE 1802 and UE 1804 (although any number of UEs may be used). In this example, the UE 1802 and the UE 1804 are illustrated as smartphones (e.g., handheld touchscreen mobile computing devices connectable to one or more cellular networks), but may also comprise any mobile or non-mobile computing device configured for wireless communication.

The UE 1802 and UE 1804 may be configured to communicatively couple with a RAN 1806. In embodiments, the RAN 1806 may be NG-RAN, E-UTRAN, etc. The UE 1802 and UE 1804 utilize connections (or channels) (shown as connection 1808 and connection 1810, respectively) with the RAN 1806, each of which comprises a physical communications interface. The RAN 1806 can include one or more base stations, such as base station 1812 and base station 1814, and one or more SMRs, such as the SMR 1834 and the SMR 1836, any of which can that enable the connection 1808 and connection 1810 (with the SMRs being controlled by the base stations, in the manner described herein).

In this example, the connection 1808 and connection 1810 are air interfaces to enable such communicative coupling, and may be consistent with RAT(s) used by the RAN 1806, such as, for example, an LTE and/or NR.

In some embodiments, the UE 1802 and UE 1804 may also directly exchange communication data via a sidelink interface 1816. The UE 1804 is shown to be configured to access an access point (shown as AP 1818) via connection 1820. By way of example, the connection 1820 can comprise a local wireless connection, such as a connection consistent with any IEEE 802.11 protocol, wherein the AP 1818 may comprise a Wi-Fi router. In this example, the AP 1818 may be connected to another network (for example, the Internet) without going through a CN 1824.

In embodiments, the UE 1802 and UE 1804 can be configured to communicate using orthogonal frequency division multiplexing (OFDM) communication signals with each other or with the base station 1812, the base station 1814, the SMR 1834, and/or the SMR 1836 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1812 or base station 1814 may be implemented as one or more software entities running on server computers as part of a virtual network. In addition, or in other embodiments, the base station 1812 or base station 1814 may be configured to communicate with one another via interface 1822. In embodiments where the wireless communication system 1800 is an LTE system (e.g., when the CN 1824 is an EPC), the interface 1822 may be an X2 interface. The X2 interface may be defined between two or more base stations (e.g., two or more eNBs and the like) that connect to an EPC, and/or between two eNBs connecting to the EPC. In embodiments where the wireless communication system 1800 is an NR system (e.g., when CN 1824 is a 5GC), the interface 1822 may be an Xn interface. The Xn interface is defined between two or more base stations (e.g., two or more gNBs and the like) that connect to 5GC, between a base station 1812 (e.g., a gNB) connecting to 5GC and an eNB, and/or between two eNBs connecting to 5GC (e.g., CN 1824).

The RAN 1806 is shown to be communicatively coupled to the CN 1824. The CN 1824 may comprise one or more network elements 1826, which are configured to offer various data and telecommunications services to customers/subscribers (e.g., users of UE 1802 and UE 1804) who are connected to the CN 1824 via the RAN 1806. The components of the CN 1824 may be implemented in one physical device or separate physical devices including components to read and execute instructions from a machine-readable or computer-readable medium (e.g., a non-transitory machine-readable storage medium).

In embodiments, the CN 1824 may be an EPC, and the RAN 1806 may be connected with the CN 1824 via an S1 interface 1828. In embodiments, the S1 interface 1828 may be split into two parts, an S1 user plane (S1-U) interface, which carries traffic data between the base station 1812 or base station 1814 and a serving gateway (S-GW), and the S1-MME interface, which is a signaling interface between the base station 1812 or base station 1814 and mobility management entities (MMEs).

In embodiments, the CN 1824 may be a 5GC, and the RAN 1806 may be connected with the CN 1824 via an NG interface 1828. In embodiments, the NG interface 1828 may be split into two parts, an NG user plane (NG-U) interface, which carries traffic data between the base station 1812 or base station 1814 and a user plane function (UPF), and the S1 control plane (NG-C) interface, which is a signaling interface between the base station 1812 or base station 1814 and access and mobility management functions (AMFs).

Generally, an application server 1830 may be an element offering applications that use internet protocol (IP) bearer resources with the CN 1824 (e.g., packet switched data services). The application server 1830 can also be configured to support one or more communication services (e.g., VoIP sessions, group communication sessions, etc.) for the UE 1802 and UE 1804 via the CN 1824. The application server 1830 may communicate with the CN 1824 through an IP communications interface 1832.

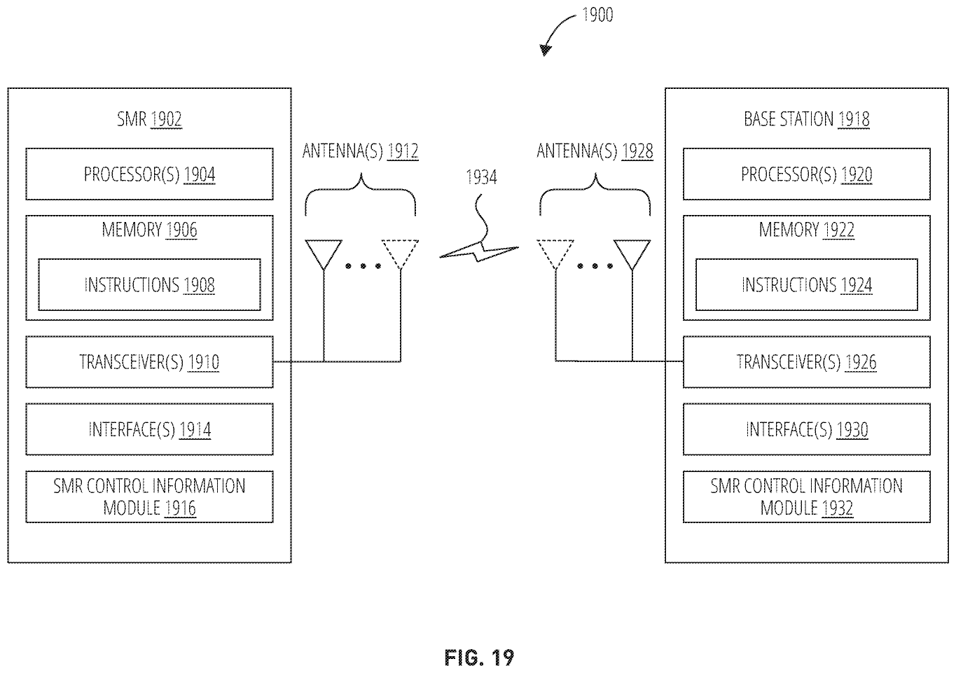

FIG. 19 illustrates a system 1900 for performing signaling 1934 between an SMR 1902 and a base station 1918, according to embodiments disclosed herein. The system 1900 may be a portion of a wireless communications system as herein described. The base station 1918 may be, for example, a gNB or an eNB of a wireless communication system.

The SMR 1902 may include one or more processor(s) 1904. The processor(s) 1904 may execute instructions such that various operations of the SMR 1902 are performed, as described herein. The processor(s) 1904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The SMR 1902 may include a memory 1906. The memory 1906 may be a non-transitory computer-readable storage medium that stores instructions 1908 (which may include, for example, the instructions being executed by the processor(s) 1904). The instructions 1908 may also be referred to as program code or a computer program. The memory 1906 may also store data used by, and results computed by, the processor(s) 1904.

The SMR 1902 may include one or more transceiver(s) 1910 that may include radio frequency (RF) transmitter and/or receiver circuitry that use the antenna(s) 1912 of the SMR 1902 to facilitate signaling (e.g., the signaling 1934) to and/or from the SMR 1902 with other devices (e.g., the base station 1918) according to corresponding RATs.

The SMR 1902 may include one or more antenna(s) 1912 (e.g., one, two, four, or more). For embodiments with multiple antenna(s) 1912, the SMR 1902 may leverage the spatial diversity of such multiple antenna(s) 1912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the SMR 1902 may be accomplished according to precoding (or digital beamforming) that is applied at the SMR 1902 that multiplexes the data streams across the antenna(s) 1912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the SMR 1902 may implement analog beamforming techniques, whereby phases of the signals sent by the antenna(s) 1912 are relatively adjusted such that the (joint) transmission of the antenna(s) 1912 can be directed (this is sometimes referred to as beam steering).

The SMR 1902 may include one or more interface(s) 1914. The interface(s) 1914 may be used to provide input to or output from the SMR 1902. For example, an SMR 1902 may include interface(s) 1914 such as microphones, speakers, a touchscreen, buttons, and the like in order to allow for input and/or output to the SMR 1902 by a user of the SMR 1902. Other interfaces of an SMR 1902 may be made up of transmitters, receivers, and other circuitry (e.g., other than the transceiver(s) 1910/antenna(s) 1912 already described) that allow for communication between the SMR 1902 and other devices and may operate according to known protocols (e.g., Wi-Fi®, Bluetooth®, and the like).

The SMR 1902 may include an SMR control information module 1916. The SMR control information module 1916 may be implemented via hardware, software, or combinations thereof. For example, the SMR control information module 1916 may be implemented as a processor, circuit, and/or instructions 1908 stored in the memory 1906 and executed by the processor(s) 1904. In some examples, the SMR control information module 1916 may be integrated within the processor(s) 1904 and/or the transceiver(s) 1910. For example, the SMR control information module 1916 may be implemented by a combination of software components (e.g., executed by a DSP or a general processor) and hardware components (e.g., logic gates and circuitry) within the processor(s) 1904 or the transceiver(s) 1910.

The SMR control information module 1916 may be used for various aspects of the present disclosure, for example, aspects of FIG. 1 through FIG. 15. The SMR control information module 1916 may configure the SMR 1902 to receive and implement SMR control information (including SMR SSB control information and SMR CSI-RS control information) from the base station 1918 in the manner described herein.

The base station 1918 may include one or more processor(s) 1920. The processor(s) 1920 may execute instructions such that various operations of the base station 1918 are performed, as described herein. The processor(s) 1920 may include one or more baseband processors implemented using, for example, a CPU, a DSP, an ASIC, a controller, an FPGA device, another hardware device, a firmware device, or any combination thereof configured to perform the operations described herein.

The base station 1918 may include a memory 1922. The memory 1922 may be a non-transitory computer-readable storage medium that stores instructions 1924 (which may include, for example, the instructions being executed by the processor(s) 1920). The instructions 1924 may also be referred to as program code or a computer program. The memory 1922 may also store data used by, and results computed by, the processor(s) 1920.

The base station 1918 may include one or more transceiver(s) 1926 that may include RF transmitter and/or receiver circuitry that use the antenna(s) 1928 of the base station 1918 to facilitate signaling (e.g., the signaling 1934) to and/or from the base station 1918 with other devices (e.g., the SMR 1902) according to corresponding RATs.

The base station 1918 may include one or more antenna(s) 1928 (e.g., one, two, four, or more). In embodiments having multiple antenna(s) 1928, the base station 1918 may perform MIMO, digital beamforming, analog beamforming, beam steering, etc., as has been described.

The base station 1918 may include one or more interface(s) 1930. The interface(s) 1930 may be used to provide input to or output from the base station 1918. For example, a base station 1918 that is a base station may include interface(s) 1930 made up of transmitters, receivers, and other circuitry (e.g., other than the transceiver(s) 1926/antenna(s) 1928 already described) that enables the base station to communicate with other equipment in a core network, and/or that enables the base station to communicate with external networks, computers, databases, and the like for purposes of operations, administration, and maintenance of the base station or other equipment operably connected thereto.

The base station 1918 may include an SMR control information module 1932. The SMR control information module 1932 may be implemented via hardware, software, or combinations thereof. For example, the SMR control information module 1932 may be implemented as a processor, circuit, and/or instructions 1924 stored in the memory 1922 and executed by the processor(s) 1920. In some examples, the SMR control information module 1932 may be integrated within the processor(s) 1920 and/or the transceiver(s) 1926. For example, the SMR control information module 1932 may be implemented by a combination of software components (e.g., executed by a DSP or a general processor) and hardware components (e.g., logic gates and circuitry) within the processor(s) 1920 or the transceiver(s) 1926.

The SMR control information module 1932 may be used for various aspects of the present disclosure, for example, aspects of FIG. 1 through FIG. 15. The SMR control information module 1932 is configured to generate and transmit SMR control information (including SMR SSB control information and SMR CSI-RS control information) from the to the SMR 1902 in the manner described herein.

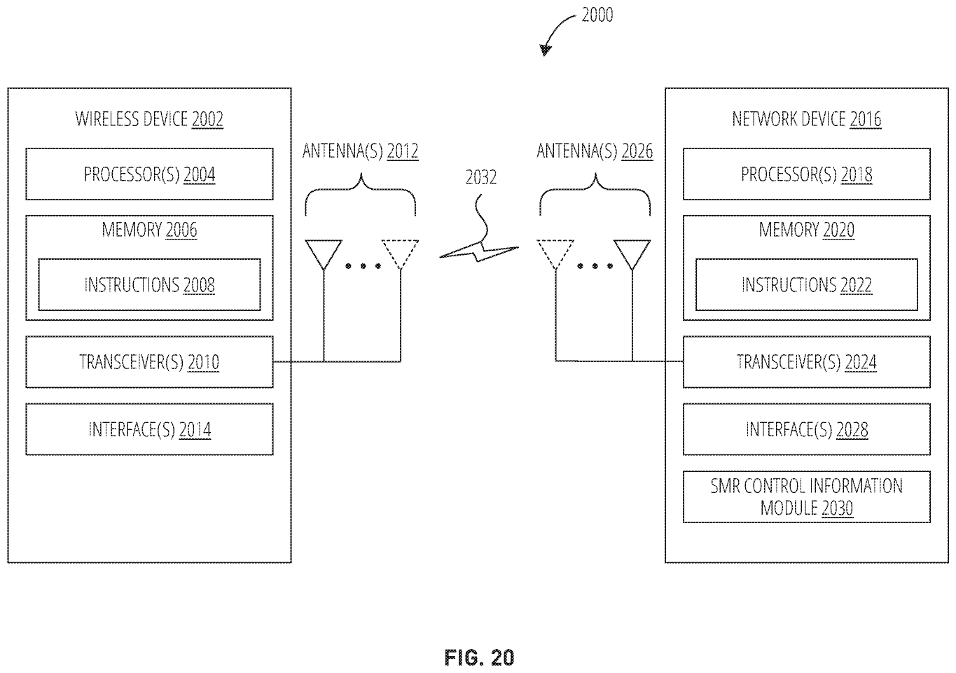

FIG. 20 illustrates a system 2000 for performing signaling 2032 between a wireless device 2002 and a network device 2016, according to embodiments disclosed herein. The system 2000 may be a portion of a wireless communications system as herein described. The wireless device 2002 may be, for example, a UE (e.g., an SMR-UE or a gNB-UE) of a wireless communication system. The network device 2016 may be, for example, a base station (e.g., an eNB or a gNB) or an SMR of a wireless communication system.

The wireless device 2002 may include one or more processor(s) 2004. The processor(s) 2004 may execute instructions such that various operations of the wireless device 2002 are performed, as described herein. The processor(s) 2004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2002 may include a memory 2006. The memory 2006 may be a non-transitory computer-readable storage medium that stores instructions 2008 (which may include, for example, the instructions being executed by the processor(s) 2004). The instructions 2008 may also be referred to as program code or a computer program. The memory 2006 may also store data used by, and results computed by, the processor(s) 2004.

The wireless device 2002 may include one or more transceiver(s) 2010 that may include radio frequency (RF) transmitter and/or receiver circuitry that use the antenna(s) 2012 of the wireless device 2002 to facilitate signaling (e.g., the signaling 2032) to and/or from the wireless device 2002 with other devices (e.g., the network device 2016) according to corresponding RATs.

The wireless device 2002 may include one or more antenna(s) 2012 (e.g., one, two, four, or more). In embodiments having multiple antenna(s) 2012, the wireless device 2002 may perform MIMO, digital beamforming, analog beamforming, beam steering, etc., as has been described.

The wireless device 2002 may include one or more interface(s) 2014. The interface(s) 2014 may be used to provide input to or output from the wireless device 2002. For example, a wireless device 2002 that is a UE may include interface(s) 2014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 2010/antenna(s) 2012 already described) that allow for communication between the UE and other devices and may operate according to known protocols (e.g., Wi-Fi®, Bluetooth®, and the like).

The network device 2016 may include one or more processor(s) 2018. The processor(s) 2018 may execute instructions such that various operations of the network device 2016 are performed, as described herein. The processor(s) 2018 may include one or more baseband processors implemented using, for example, a CPU, a DSP, an ASIC, a controller, an FPGA device, another hardware device, a firmware device, or any combination thereof configured to perform the operations described herein.

The network device 2016 may include a memory 2020. The memory 2020 may be a non-transitory computer-readable storage medium that stores instructions 2022 (which may include, for example, the instructions being executed by the processor(s) 2018). The instructions 2022 may also be referred to as program code or a computer program. The memory 2020 may also store data used by, and results computed by, the processor(s) 2018.

The network device 2016 may include one or more transceiver(s) 2024 that may include RF transmitter and/or receiver circuitry that use the antenna(s) 2026 of the network device 2016 to facilitate signaling (e.g., the signaling 2032) to and/or from the network device 2016 with other devices (e.g., the wireless device 2002) according to corresponding RATs.

The network device 2016 may include one or more antenna(s) 2026 (e.g., one, two, four, or more). In embodiments having multiple antenna(s) 2026, the network device 2016 may perform MIMO, digital beamforming, analog beamforming, beam steering, etc., as has been described.

The network device 2016 may include one or more interface(s) 2028. The interface(s) 2028 may be used to provide input to or output from the network device 2016. For example, a network device 2016 that is a base station may include interface(s) 2028 made up of transmitters, receivers, and other circuitry (e.g., other than the transceiver(s) 2024/antenna(s) 2026 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2016 may include an SMR control information module 2030. The SMR control information module 2030 may be implemented via hardware, software, or combinations thereof. For example, the SMR control information module 2030 may be implemented as a processor, circuit, and/or instructions 2022 stored in the memory 2020 and executed by the processor(s) 2018. In some examples, the SMR control information module 2030 may be integrated within the processor(s) 2018 and/or the transceiver(s) 2024. For example, the SMR control information module 2030 may be implemented by a combination of software components (e.g., executed by a DSP or a general processor) and hardware components (e.g., logic gates and circuitry) within the processor(s) 2018 or the transceiver(s) 2024.

The SMR control information module 2030 may be used for various aspects of the present disclosure, for example, aspects of FIG. 1 through FIG. 15. For a network device 2016 that is an SMR, the SMR control information module 2030 is configured to receive and implement SMR control information (including SMR SSB control information and SMR CSI-RS control information) from a base station in the manner described herein (e.g., to control an SMR SSB beam sweep or an SMR CSI-RS beam sweep used by a wireless device 2002 in the case that the wireless device 2002 is an SMR-UE). For a network device 2016 that is a base station, the SMR control information module 2030 is configured to generate and send SMR control information (including SMR SSB control information and SMR CSI-RS control information) to an SMR in the manner described herein, while maintaining its connection with the wireless device 2002 in the case that the wireless device 2002 is a connected gNB-UE.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a smart repeater (SMR), comprising:
reporting, to a base station, SMR capability information;
receiving, from the base station, SMR control information corresponding to the SMR capability information, the SMR control information comprising a first portion configuring a synchronization signal block (SSB) burst set for an SMR SSB beam sweep and a second portion configuring a channel state information reference signal (CSI-RS) resource set for an SMR CSI-RS beam sweep; and
performing, based on the SMR control information, at least one of the SMR SSB beam sweep using SSBs of the SSB burst set and the SMR CSI-RS beam sweep using CSI-RS resources of the CSI-RS resource set.

2. The method of claim 1, wherein at least one of the first portion and the second portion is received in high-layer signaling on an physical downlink shared channel (PDSCH) for the SMR.

3. The method of claim 1, wherein a first one of the first portion and the second portion is received in downlink control information (DCI) of a first DCI format having cyclic redundancy check (CRC) bits scrambled by a first radio network temporary identifier (RNTI) that identifies that the first DCI format includes the first one of the first portion and the second portion.

4. The method of claim 3, wherein the first RNTI of the first DCI format is different than a second RNTI of a second DCI format used by the base station corresponding to a second one of the first portion and the second portion.

5. The method of claim 3, wherein the DCI comprises a one-bit identifier that indicates that the DCI includes the first one of the first portion and the second portion.

6. The method of claim 3, wherein the DCI is received in a first search space set that identifies the first one of the first portion and the second portion.

7. The method of claim 3, further comprising performing PDCCH monitoring for the DCI according to a control resource set (CORESET) configuration that includes:
a number of consecutive symbols for a CORESET;
a set of resource blocks (RBs) for the CORESET;
control channel element (CCE) to resource element group (REG) mapping parameters for the CORESET; and
an antenna port quasi co-location (QCL) parameter for the CORESET.

8. The method of claim 7, wherein the number of consecutive symbols is a value of two or three that is one of pre-configured to the SMR and pre-defined for the SMR.

9. The method of claim 7, wherein the number of consecutive symbols for the CORESET is one of seven symbols and fourteen symbols.

10. The method of claim 7, wherein one of the CCE to REG mapping parameters is pre-defined to indicate for a use of non-interleaved CCE to REG mapping.

11. The method of claim 7, wherein the antenna port QCL parameter is pre-defined to indicate that a most recent SSB is a QCL source.

12. The method of claim 3, further comprising performing PDCCH monitoring for the DCI according to a search space set configuration that includes:
a PDCCH monitoring periodicity;
a PDCCH monitoring offset; and
a number of PDCCH candidates per control channel element (CCE) aggregation level (AL).

13. The method of claim 12, wherein the PDCCH monitoring periodicity is a value of 20 milliseconds that is one of pre-configured to the SMR and pre-defined for the SMR.

14. The method of claim 12, wherein the search space set configuration further defines that a PDCCH monitoring occasion for the DCI is limited to a first two or first three symbols of a slot.

15. The method of claim 12, wherein the number of PDCCH candidates per CCE AL is a value of one or two that is one of pre-configured to the SMR and pre-defined for the SMR.

16. The method of claim 1, wherein:
the performing, based on the SMR control information, one of the SMR SSB beam sweep and the SMR CSI-RS beam sweep comprises performing the SMR SSB beam sweep based on the first portion; and
the method further comprises receiving, from the base station, based on the first portion, the SSB burst set for the SMR SSB beam sweep, wherein the SMR SSB beam sweep occurs within a period of an SMR SSB burst periodicity.

17. The method of claim 16, wherein the first portion indicates the SMR SSB burst periodicity.

18. The method of claim 16, wherein:
the first portion includes an offset value; and
the SSB burst set is received within the period according to the offset value.

19. The method of claim 18, wherein the offset value is given in units of half radio frames.

20. The method of claim 18, wherein the offset value is given in units of a length of a maximum number of SSBs that are supported when using a current subcarrier spacing.

21-76. (canceled)
